(19) United States
(12) Patent Application Publication
(10) Pub. No.: US 2015/0058709 A1
(43) Pub. Date: Feb. 26, 2015

(54) METHOD OF CREATING A MEDIA COMPOSITION AND APPARATUS THEREFORE

(71) Applicant: Michael Edward ZALETEL, Gilbert, AZ (US)

(72) Inventor: Michael E. Zaletel, Ponce, PR (US)

(21) Appl. No.: 14/374,719

(22) PCT Filed: Jan. 28, 2013
(86) PCT No.: PCT/US2013/023499

§ 371 Date: Jul. 25, 2014

Related U.S. Application Data
(60) Provisional application No. 61/591,120, filed on Jan. 26, 2012.

(51) Int. Cl. G06F 3/14; G06F 3/0484; H04L 29/06

(52) U.S. Cl. CPC G06F 3/14; H04L 65/608; G06F 3/0484
USPC 715/202

(57) ABSTRACT

A media composition formation program method and device, in one aspect, the invention can be a method of creating a final media composition comprising: a) receiving a plurality of low resolution media streams from a plurality of remote electronic devices; b) displaying visual indicia the low resolution media streams; c) activating one or more of the low resolution media streams m response to user input; d) for each low resolution media stream that is activated in step c), recording a low resolution media clip segment of that Sow resolution media stream in an interim media composition; e) for each low resolution media clip segment recorded in the interim, media composition, receiving a high resolution media clip segment that, corresponds to that Sow resolution media clip segment; and f) automatically replacing the low resolution media clip segments in the interim media composition with the high resolution media clip segments.

### CROSS REFERENCE TO RELATED PATENT APPLICATIONS

The present application claims the benefit of U.S. Provisional Patent Application Ser. No. 61/931,911, filed Jan. 26, 2012, the entirety of which is hereby incorporated by reference.

### FIELD OF THE INVENTION

The present invention relates to methods and apparatuses for recording and storing media representations perceived by media recording devices.

### BACKGROUND OF THE INVENTION

The proliferation of media recording devices has resulted in many people having a sensory recording device of some kind with them at all times. In many instances, a user will sporadically capture audio, videos and still photographs with their device at various times during one event (e.g. a birthday party, a tourist attraction, a sporting event, etc.). All of the recorded media typically stay on the user's device as separate individual files until, at some later time, the user downloads the media files to a personal computer or loads them into a mobile video editing application one at a time.

Using current technologies, an individual user can only record media that the user can perceive from his or her own electronic device (i.e., camera, microphone, camcorder, smart phone, etc.). It may be desirable for an individual to record media from a music concert, sporting event or other event that the user is unable to attend, or from a vantage point that is different than user's vantage point. A user also might want to create a composition in real-time that combines media from his or device with media from many other devices. Thus, a need exists for a method and/or apparatus for recording and live-editing media onto a user's electronic device from one or more remote media capture device(s).

### SUMMARY OF THE INVENTION

The present invention relates to methods and apparatuses for recording media of a remote nature perceived by a remote sensor of a remote media recording device onto a first memory device of a first portable electronic device. In certain embodiments, the first memory device records a low resolution or placeholder version of the remote media recording device input, the low resolution or placeholder version being later replaced by a corresponding high resolution version of the media input.

In one embodiment, the invention can be a method of creating a final media composition using a media composition program residing on a first electronic device comprising a first display device, a first memory device, and first user input means, the method comprising: a) receiving, on the first electronic device, a plurality of low resolution media streams of high resolution media clips from a plurality of remote electronic devices; b) displaying, in the first display device, visual indicia of each of the low resolution media streams being received by the first electronic device; c) activating one or more of the low resolution media streams being received by the first electronic device in response to user input via the first user input means; d) for each low resolution media stream that is activated in step c), recording a low resolution media clip segment of that low resolution media stream in an interim media composition that resides on the first memory device; e) for each low resolution media clip segment recorded in the interim media composition, receiving on the first electronic device a high resolution media clip segment from the remote electronic device that corresponds to that low resolution media clip segment; and f) automatically replacing the low resolution media clip segments in the interim media composition with the high resolution media clip segments to create the final media composition comprising the high resolution media clip segments.

In another embodiment, the invention can be a method of creating a video composition comprising: a) displaying, in a first display device of a first electronic device, a plurality of remote camera views perceived by a plurality of remote camera lenses of a plurality of remote electronic devices; b) activating one or more of the plurality of the remote camera views displayed in the first display device via user input means of the first electronic device; c) for each remote camera view that is activated in step b), recording, on a first memory device of the first electronic device, a low resolution video clip segment of the remote camera view as part of an interim video composition, and wherein for each remote camera view that is activated in step b); d) for each low resolution video clip segment recorded in step c), acquiring from the remote electronic devices a high resolution video clip segment that corresponds to that low resolution video clip segment; and e) automatically replacing the low resolution video clip segment in the video composition recorded on the first memory device of the first electronic device with the high resolution video clip segments.

In yet another embodiment, the invention can be a non-transitory computer-readable storage medium encoded with instructions which, when executed on a processor of a first electronic device, perform a method comprising: a) displaying, in a first display device of a first electronic device, a plurality of remote camera views perceived by a plurality of remote camera lenses of a plurality of remote electronic devices; b) activating one or more of the plurality of the remote camera views displayed in the first display device in response to user input inputted via user input means of the first electronic device; c) for each remote camera view that is activated in step b): (1) recording, on a first memory device of the first electronic device, a low resolution video clip of the remote camera view as part of a video composition; and (2) generating and transmitting a first record signal to the remote electronic devices, thereby causing a high resolution video clip of the remote camera view to be recorded on the remote electronic device capturing that remote camera view; d) for each high resolution video clip recorded in step c), generating and transmitting a signal that causes the high resolution video clips from the remote electronic devices to be transmitted to the first electronic device; and e) upon the first portable electronic device receiving the high resolution video clips transmitted in step d), automatically replacing the low resolution video clips in the video composition recorded on the first memory device of the first electronic device with the high resolution video clips.

In still another embodiment, the invention can be a method of creating a final media composition using a media composition program residing on a first electronic device comprising a first display device, a first memory device, and first user input means, the method comprising: a) receiving, on the first electronic device, a plurality of low resolution media streams of high resolution media clip files from one or more databases, the high resolution media clip files stored on the one or more databases; b) displaying, in the first display device, visual indicia of each of the low resolution media streams being received by the first electronic device; c) activating one or more of the low resolution media streams being received by the first electronic device in response to user input via the first user input means; d) for each low resolution media stream that is activated in step c), recording a low resolution media clip segment of that low resolution media stream in an interim media composition that resides on the first memory device; e) for each low resolution media clip segment recorded in the interim media composition, receiving on the first electronic device a high resolution media clip segment from the one or more databases that corresponds to that low resolution media clip segment; and f) automatically replacing the low resolution media clip segments in the interim media composition with the high resolution media clip segments to create the final media composition comprising the high resolution media clip segments.

In a further embodiment, the invention can be a method of creating a video composition comprising: a) displaying, in a first display device of a first portable electronic device, a first camera view perceived by a first camera lens of the first portable electronic device; b) transmitting, to the first portable electronic device, a plurality of low resolution video streams of high resolution video clips previously stored in one or more databases; c) displaying, in the first display device of the first electronic device, the low resolution video streams, wherein the first camera view and the low resolution video streams are simultaneously displayed in the first display device; d) recording, on the first memory device of the first portable electronic device, a low resolution video clip for each of the low resolution video streams activated by a user as part of a video composition; e) for each low resolution video clip recorded on the first memory device of the first portable electronic device, transmitting corresponding ones of the high resolution clips from the one or more databases to the first portable electronic device; and f) automatically replacing the low resolution video clips in the video composition recorded on the first memory device of the first portable electronic device with the high resolution video clips.

In an even further embodiment, the invention can be a method of creating a final media composition using a media composition program residing on a first electronic device comprising a first display device, a first memory device, and first user input means, the method comprising: a) displaying, in the first display device, a visual indicia for each of a plurality of electronic media recording devices; b) recording, on each of the electronic media recording devices, a perceived event as a media clip that contains an electronic media recording device identifier; c) selectively activating each of the visual indicia of the plurality of electronic media recording devices during step b) to generate and record a proxy clip segment in an interim video composition on the first memory device, wherein each proxy clip segment is associated with the electronic media recording device whose visual indicia was activated to generate that proxy clip segment and a temporal period; d) for each proxy clip segment recorded in the interim media composition, receiving on the first electronic device the media clip recorded in step b); and e) for each media clip received in step d), matching the media clip with the corresponding proxy clip segment based on the electronic media recording device identifier and automatically extracting a segment of the media clip that corresponds to the temporal period of that proxy clip segment; and f) for each media clip segment extracted in step e), automatically replacing the proxy clip segment to which that media clip segment is matched with that media clip segment to create the final media composition comprising the media clip segments.

In other embodiments, the invention can be a non-transitory computer-readable storage medium encoded with instructions which, when executed on a processor of a first electronic device, perform any one of the methods described above.

In yet other embodiments, the invention can be an electronic device comprising: a first processor; a first memory device; a first transceiver; and instructions residing on the first memory device, which when executed by the first processor, causes the first processor to perform any of the methods described above.

### BRIEF DESCRIPTION OF THE DRAWINGS

FIG. 1 is a schematic of an electronic device in accordance with an embodiment of the present invention.

FIG. 2 is a schematic diagram of a system overview in accordance with an embodiment of the present invention.

FIG. 3 is a schematic diagram illustrating communication between a first electronic device and a plurality of remote electronic devices.

FIG. 4 is a screen shot of a login page in accordance with an embodiment of the present invention.

FIG. 5 is a screen shot of a list of remote electronic devices that have initiated a sharing status in accordance with an embodiment of the present invention.

FIG. 6 is a screen shot of a first electronic device illustrating the streaming of multiple low resolution video clips from a plurality of remote electronic devices in accordance with an embodiment of the present invention.

FIG. 7 is a screen shot illustrating an edit switching window in accordance with an embodiment of the present invention.

FIG. 8 is a screen shot illustrating how a user can select audio tracks for the audio for a multi-camera session in accordance with an embodiment of the present invention.

FIG. 9 is a screen shot illustrating a searching tool for locating video clips based on qualification criteria in accordance with an embodiment of the present invention.

### DETAILED DESCRIPTION OF THE INVENTION

The present invention relates to methods and apparatus for recording media clips such as camera views or audio input from one or more remote electronic devices (which may be referred to herein as players) positioned at various different locations throughout the world onto a first electronic device (which may be referred to herein as a stage). In certain embodiments, the remote electronic devices may be remote media recording devices that are capable of recording any type of media including video, audio, still photos, text, graphics or the like. The remote electronic devices are deemed remote due to the remote electronic devices being at a location that is different from the location of the first electronic device that is acting as a stage, regardless of whether one or more of the remote electronic devices is adjacent to the first electronic device or thousands of miles away from the first electronic device.

The first electronic device or stage is able to create a media composition with various media clips or feeds from the different remote electronic devices or players. Thus, the first electronic device or stage can record media from the remote electronic devices and record/store the media onto its own memory. In certain embodiments whereby the media is video, the first electronic device or stage can record video based on the camera views perceived from camera lenses of one or more of the remote electronic devices or players and store the recorded video from the one or more remote electronic devices or players onto its own memory. The first electronic device or stage can simultaneously record video based on the camera view perceived from its own camera lens and store that video into its memory (the first electronic device can alternatively store other types of media, such as that listed above).

In creating the media composition, the user of the first electronic device can switch back and forth among and between the various views so that the media composition that is created is a fully edited media composition. The media composition is created and stored into the memory of the first electronic device or stage as a composition of the media recorded from the remote electronic devices/players and/or the media recorded directly by the first electronic device/stage. The user can then use editing techniques to maneuver the different media clips by changing their order in the final media composition and create transitions in the media composition, such as that which is described in U.S. Patent Application Publication No. 2012/0308209, filed Sep. 8, 2011, the entirety of which is incorporated herein by reference.

In one embodiment, the present invention is an application for an electronic device, which can be a portable electronic device such as a mobile communication device, a camera or a desktop computer. In one embodiment, the application is a video composition creation program such that the media described herein above is video. In another embodiment, the application is an audio composition creation program such that the media described herein above is audio. In other embodiments the application is an audio/video/still photo composition creation program. Any combination of media can be used with the invention described herein.

In some embodiments, the first electronic device or stage comprises at least one camera/camcorder lens or at least one audio input sensor. However, it should be noted that in alternate embodiments the first electronic device may not comprise a camera/camcorder, but rather may remotely connect to another electronic device that does comprise a camera/camcorder. Furthermore, in certain embodiments the first electronic device or stage merely comprises a microphone for detecting and storing audio. The electronic device or mobile communication device may be a smart phone or tablet, such as but not limited to, an iPhone® or an iPad®, or a Blackberry®, Windows®, Mac OS®, Bada® or Android® enabled device, that preferably but not necessarily comprises at least one camera/camcorder. In such embodiments, the present invention may be an application that can be purchased and downloaded to the electronic device or mobile communication device by the user. As understood in the art, the download of the application may be done through a wired or wireless connection to the manufacturer's or service provider's application database. Thereafter, the present invention would reside on a computer readable medium located within the portable electronic device, mobile communication device, desktop computer or mobile camera/camcorder.

Furthermore, it should be appreciated that although much of the detail of the description of the invention below is directed to streaming, recording and saving video clips, the invention can also operate by streaming, recording and saving audio clips, still photos, text, graphics, music and the like. Thus, although video is the media that is predominantly used in the description, any other type of media can be used including still photos, text, graphics, audio, music and the like. At any point in which video clips are described as the media of choice in this description, any other media types can be used.

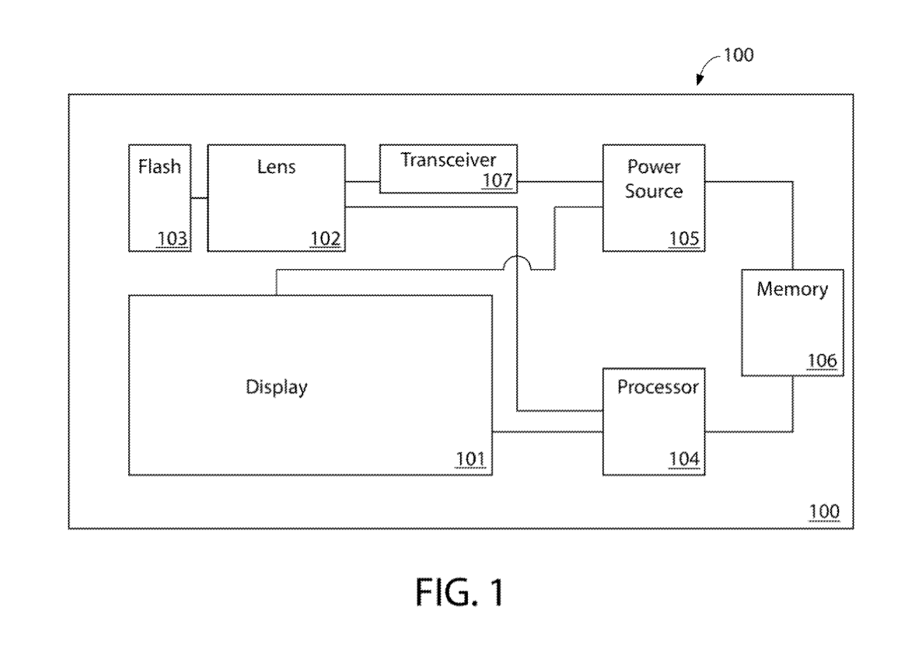

Referring to FIG. 1, a schematic of an electronic device 100 according to one embodiment of the present invention is illustrated. As noted above, the electronic device 100 may be a portable electronic device, which includes mobile communication devices such as a smart phone or tablet that comprises a camera/camcorder, whereby the user downloads the present invention as an application and stores the application on a computer readable medium located within the electronic device 100. In other embodiments, the electronic device 100 may be manufactured with the features of the present invention built in. The electronic device 100 comprises a display device 101, a lens 102, a flash 103, a processor 104, a power source 105, a memory 106 and a transceiver 107. It should be noted that in some alternate embodiments, the lens 102 and the flash 103 may be omitted from the electronic device 100. Further, as discussed in more detail below, the electronic device 100 may comprise any number of lenses 102 or flashes 103.

In one embodiment of the present invention, the electronic device 100 is a mobile communication device such as a mobile phone, smart phone or tablet, such as but not limited to, an iPhone®, iPad®, Android®, Blackberry®, Bada® or Windows® enabled device. The invention, however, is not so limited and the electronic device 100 may also be a digital camera, camcorder or surveillance camera that has the present invention stored in a computer readable medium therein, or a desktop computer that has an attached or embedded camera and the present invention stored in a computer readable medium therein. The electronic device 100 may also be a camera, camcorder or the like that does not have the present invention stored therein, but rather is in communication (wireless or wired) with another electronic device that does have the present invention stored therein. In still other embodiments, the electronic device 100 acts as a bridge for an external camera device over WiFi or other communication pathways. It should be noted that in alternate embodiments, the present invention may be stored on a computer readable medium within the electronic device 100 prior to the user purchasing the electronic device 100.

The processor 104 is configured to control the operation of the display device 101, lens 102, flash 103, power source 105, memory 106 and transceiver 107. The power source 105, which may be batteries, solar power or the like, is configured to provide power to the display device 101, lens 102, flash 103, processor 104, memory 106 and transceiver 107. The memory 106 is configured to store photographs and/or video clips recorded by the lens 102 of the electronic device 100 or recorded by a lens of a remote or second electronic device that is different from the electronic device 100, as will be better understood from the discussion below. Of course, the memory 106 can also be used to store audio, graphics, text or any other type of media perceived by a remote electronic device with which the electronic device 100 is in operable electronic communication. The transceiver 107 is capable of transmitting signals from the electronic device 100 to remote electronic devices and is also capable of receiving signals from the remote electronic devices. In some instances, the transceiver 107 communicates with remote electronic devices through a server. Thus, the transceiver 107 enables communication among and between various different electronic devices.

The lens 102 is a standard camera or camcorder lens that is configured to record video clips and photographs in response to a user input. In one embodiment, the electronic device 100 of the present invention may include more than one lens 102. For example, in one embodiment, the electronic device 100 may comprise a first lens on the front of the electronic device 100 and a second lens on the back of the electronic device 100.

The flash 103 is configured to provide light to the area being recorded by the lens 102. In one embodiment where the camera/camcorder of the electronic device 100 comprises more than one lens 102, the electronic device 100 may also include more than one flash 103, each flash 103 corresponding to a lens 102. However, it should be noted that the invention is not so limited and in alternate embodiments the flash 103 may be omitted. In certain embodiments both the lens 102 and the flash 103 may be omitted. Specifically, in embodiments wherein the media is not video or is not still photography, the lens 102 and the flash 103 will not be necessary.

In certain embodiments that include the lens 102 and wherein the invention is used to record video or still photographs, the display device 101 is configured to display a view from the perspective of the lens 102 to enable the user to see the area of which they are taking a photograph or video clip. Thus, the display device 101 is configured to display an image of a real-world event perceived by the lens 102 of the electronic device 100, prior to, during and after the recording of a video clip or photograph. Alternatively, as will be understood from the description below, the display device 101 can be configured to display an image of a real-world event perceived by a camera lens of another portable electronic device with which the electronic device 100 is in communication. In one embodiment, the display device 101 is a touch-screen that further comprises a graphical user interface (GUI) through the use of an on-screen touch interface configured to receive user inputted commands. In such embodiments, the user input means referred to herein is achieved by a user touching the GUI in a desired location to achieve a desired functionality. In alternate embodiments, the electronic device 100) may further comprise a separate, mechanical user interface, such as, for example buttons, triggers, or scroll wheels.

As noted above, in one embodiment, the present invention resides on a computer readable medium within a mobile communication device such as a smart phone or tablet. In such embodiments, the electronic device 100 may be configured such that if a video clip, audio clip, or photograph is being recorded and a composition is being created when the user receives a phone call, text message, system alert, or simply needs to leave the application, the video clip, photograph or audio clip and/or composition is automatically saved or cached in the memory 106 so not to be lost.

In alternate embodiments, the electronic device 100 may further comprise advanced features such as a global positioning system (GPS) chip, a compass, an accelerometer chip, a gyroscope chip, a thermometer chip, a temperature sensor, a facial detection system or service Application Programming Interface (“API”), a voice detection system or service API, a Speech-To-Text (STT) system or service API, a Text-To-Speech (TTS) system or service API, a translation system or service, a pixel-motion detection system or service API, a music database system or service, a heart rate sensor, a near field communication (NFC) chip, a radio frequency identification (RFID) chip, an ambient light sensor, a motion sensor, an audio recording microphone, an altimeter chip, a Wi-Fi chip and/or a cellular chip. The present invention is further configured to monitor and save any data recorded or obtained by any of the above mentioned chips, sensors, systems and components (collectively referred to hereinafter as “advanced features”). Further, the resulting data recorded or obtained by any of the advanced features may be saved as metadata and incorporated into recorded video clips, photographs or compositions created by the present invention. The incorporation of such data may be may be done in response to a user input or automatically assigned by the video composition creation program via a settings screen. Examples of the functionality of the advanced features of the electronic device 100 are discussed below. It should be understood that the descriptions below are examples and in no way limit the uses or the resulting data obtained via the advanced features in the present invention.

GPS coordinates, compass headings, accelerometer and gyroscope readings, temperature and altitude data may be recorded and saved into a recorded video clip, photograph or composition. For further example, an assisted GPS chip could be utilized within the functionality of the present invention to provide such things as automatic captions or titles with location (Philadelphia, Pa.) by looking up GPS coordinates in a world city database on the fly. This may allow users to record live video from cameras worldwide, whereby each recorded media segment could show the GPS coordinates or city. GPS could also be used to display running log of distance traveled from beginning of video to end of video or for example, current speed in miles per hour.

The digital compass chip could be utilized to optionally display (burn-in) to the video clip or composition the direction the camera is facing such as SW or NNE 280 degrees. Further, a compass chip could also be used in combination with GPS, Gyroscope and a HUD (heads up display) to help a user replicate a video taken years prior at same exact location. For example, a user could take a video at the same spot every month for two years and use the present invention to load older, previously recorded video clips and then add a newly recorded video clip taken at precisely the same location, direction and angle of view.

The axis gyroscope could be used for scientific applications along with accelerometer data and could be burned into a recorded video clip or composition for later analysis. Further, it also could be used to auto-stabilize shaky video clips or photographs recorded by the present invention. An altimeter could be used to burn in altitude information into a recorded media segment. This information could appear at end of the composition in the credits automatically or could be burned-in and adjusting real-time on a video clip or composition to show ascent or descent.

The temperature sensor could be used to automatically add temperature range to credits or to burn in on video. Further, a heart rate sensor could be used if a user wants heart rate information to be shown on a video clip, for example if the user is on a roller coaster.

The Facial Detection system or service API can be used to determine the number of unique persons in the video clip(s), their names and other related information if available locally on the device 100 or via the Internet. Information acquired via the facial detection system or service API may be used to automatically add captions, bubbles or applicable information on video clips, photographs, the title screen, the credits screen or any other portion of the finalized composition.

Similar to the Facial Detection system or service API, the Voice Detection system or service API can be used to determine the number of unique persons in the video clip(s), their identities or names and other related information if available locally on the device or via the Internet. Information acquired via the voice detection system or service API may be used to automatically add captions, bubbles or applicable information on video clips, photographs, the title screen, the credits screen or any other portion of the finalized composition.

The Speech-To-Text system or service API can be used to convert the spoken word portions of a recorded audio track of a video clip or the audio track of an audio recording into written text where possible for the purposes of automatically adding subtitles, closed-captioning or meta-data to a video clip or the final composition.

The Text-To-Speech system or service API can be used to convert textual data either gathered automatically, such as current time, weather, date and location, or inputted by the user, such as titles and credits, into spoken voice audio for the purposes of automatically adding this audio to a recorded video clip or the final composition. This may be used to assist the visually impaired or in combination with the Translation Service API to convert the text gathered from the Speech-To-Text service into spoken audio track in an alternate language.

The Translation system or service API can be used for the purposes of automatically converting textual data either gathered automatically, such as current time, weather, date and location, or input by the user, such as titles and credits, into another language for localization or versioning when sharing over worldwide social networks or in combination with Speech-To-Text and Text-To-Speech to provide visual or audible translations of content.

A Pixel-Motion Detection system or service API can be used to determine the speed of movement either of the camera or the recording subject for the purposes of smoothing out camera motion for an individual recorded video clip or the final composition. Further, the Pixel-Motion Detection system or service API may also be used to automatically select a music background or sound FX audio based on the measured movement for an individual recorded video clip or the final composition. In one embodiment of the present invention, the Pixel-Motion Detection system of service API uses the beats per minute of a song to determine whether it matches the measured movement for a recorded video clip or final composition. In alternate embodiments, the determination of whether a song is “fast” or “slow” may be determined by the user.

A music database system or service API can be a locally or publicly accessible database of songs or tracks with information such as appropriate locations, seasons, times of day, genres and styles for the purposes of using known information about the video composition, and automatically selecting and incorporating a particular music track into a finalized composition based on the known information. For example, such a database might suggest a Holiday song on a snowy day in December in Colorado, USA or a Beach Boys song on a Sunny Day at the beach in San Diego USA. In one embodiment, the song would be automatically added to the composition to simplify user input. In alternate embodiments, the user has the ability to selectively choose the variables that determine which songs are to be incorporated into the finalized composition.

An NFC chip could be used to display on a media segment the information communicated by nearby NFC or RFID chips in products, signs or etc. An ambient light sensor could be used to adjust exposure or to add ambient light data to meta data for later color correction assistance in editing. A proximity sensor could be set somewhere on the face of the mobile device and is intended to detect when the phone is near a user's ear. This may be used to help control the present invention, for example, such as by allowing a user to put their finger over the sensor to zoom in instead of using touch screen or other user interface.

A Wi-Fi chip may be used for higher performance mobile devices and for live connection to the Internet for city lookups from GPS data and other information that may be desired in credits or as captions. The Wi-Fi chip could also be used for remote video or audio phone call and for those calls to be recorded live with permission as a part of the composition.

An audio recording microphone may be used to record audio, but could also be used to control the present invention. For example, the microphone could be used for certain functions, such as pause, resume and room via voice commands or to auto-trigger recording of next live clip in surveillance situations. If two microphones are used, they could be used to detect compass direction of a sound being recorded out of the camera lens's view.

A motion sensor could be used to actively control the application without human intervention and to auto-trigger the recording of a next live clip in surveillance situations. Further, a motion sensor could be used to change the shutter speed in real-time to reduce motion blur on a recorded media segment.

In other alternate embodiments, the electronic device 100 may comprise a three-dimensional (3D) dual-lens camera. In such embodiments, the present invention is further configured to record 3D video clips and photographs, and include metadata that comprises depth information obtained from one of the above mentioned advanced features into a finalized composition.

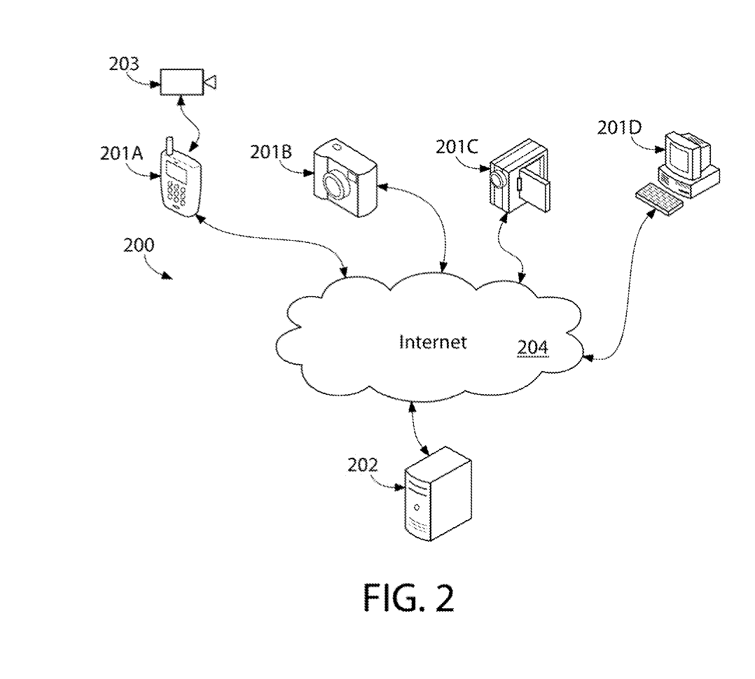

Referring now to FIG. 2, a schematic diagram of a system overview of one embodiment of the present invention is illustrated. The system 200 comprises a plurality of electronic devices 201A-201D and a server 202 that communicate via the Internet 204. Each of the electronic devices 201A-201D may be a portable electronic device, and in certain embodiments each of the electronic devices 201A-201D includes a camera with a camera lens. More specifically, in certain embodiments each of the electronic devices 201A-201D includes all of the components described above with reference to FIG. 1 (i.e., all of the components of the electronic device 100). For example, each one of the electronic devices may be a smart phone, such as but not limited to the iPhone®, a digital camera, a digital video camera, a personal computer or laptop. Although only a couple electronic devices 201A-201D are illustrated, the invention is not so limited and may comprise any number of the above mentioned electronic devices. Furthermore, any various numbers of combinations of the different types of electronic devices can be used within the scope of the present invention. The server 102 comprises computer executable programs to perform the tasks and functions described herein and facilitates communication between the various electronic devices 201A-201D.

In the exemplified embodiment of FIG. 2, the electronic devices 201A-D are in operable electronic communication with the server 202 via the Internet 204. However, in alternate embodiments the electronic devices 201A-D may be in operable electronic communication with the server 202 via a satellite network, a common carrier network(s), Wi-Fi, WiMAX or any combination thereof. In accordance with the present invention, the server 202 is configured to allow for operable communication between the electronic devices 201A-D. Nonetheless, it should be noted that in one embodiment, the server 102 may be omitted and the electronic devices 201A-D can be in operable electronic communication with one another directly via the Internet 204, a satellite network, a common carrier network(s), Wi-Fi, WiMAX or any combination thereof.

The present invention allows for a particular one of the electronic devices 201A-D, called a stage, to view and record photographs and video clips from the lens of any of the other electronic devices 201A-D, called players. According to one embodiment, each electronic device 201A-D comprises a computer executable program that allows for the operable electronic communication between the devices 201A-D. Further, it should be noted that any electronic device may be a stage, a player, or both, and their roles may change at any time. In certain embodiments, multiple electronic devices that are each operating as a stage may be operably electronically communicating with one another

In certain embodiments, any one of the electronic devices 201A-D may be in operable electronic communication with another electronic device 203, which may be a portable electronic device as has been described herein above or a non-portable electronic device. In such embodiments, the electronic device 201A may generate its video feed from the electronic device 203. The electronic device 203 may or may not have the inventive application or program on the device. Specifically, in some embodiments the electronic device 201A is acting as a bridge for an external camera device (i.e., electronic device 203) over WiFi.

According to one embodiment of the invention, which will be described in more detail below, after a stage decides to record a photo, video clip or other media from a player, the player stores the video clip locally in memory and transmits a low resolution video to the stage for a preview. As noted above, the transmission of the low resolution video (and all other communication) may be done via the server 202 or not, and may be done over the Internet 204, satellite network, common carrier network(s), wi-fi, WiMAX or any combination thereof. Thereafter, when the player is done recording or when the stage is finished recording via the player's camera lens, the high resolution video clip recorded by the player is transmitted to the stage.

When the stage receives the high-resolution video clip, the stage replaces the low resolution video clip with the high resolution video clip in its memory and on a timeline, regardless of whether that position on the timeline is before other, subsequently recorded video clips. Therefore, the present invention overcomes packet drop issues that occur when attempting to stream higher resolution clips or situations when an electronic device 201A-D may lose connection altogether. This allows for live, non-linear recording from one electronic device 201A-D by another.

Further, the present invention allows for a particular stage to be connected to and record from more than one player at any particular time. In such instances, the stage may choose which players it would like to be the main display on its application. In embodiments that comprise the server 202, not only does the server 202 regulate the communication between the multiple electronic devices 201A-D, but the server 202 also stores the recorded video clips, audio clips and photographs on a database of the server 202. Thereafter, any electronic device 201A-D may incorporate a saved video clip, audio clip, or photograph into their composition. These saved video clips, audio clips, and photographs are saved in a library as pre-recorded media that can be used to simulate or emulate players. This feature will be discussed in more detail below.

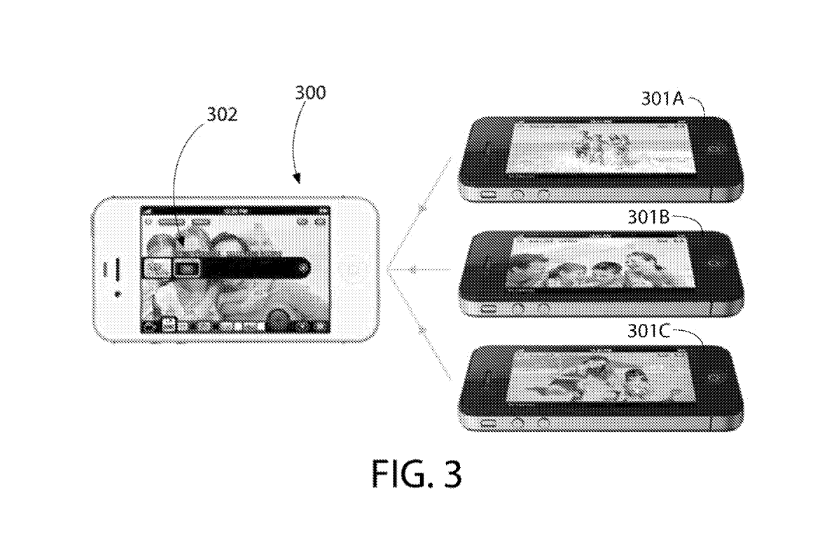

Referring now to FIG. 3, a schematic diagram illustrating communication between a first electronic device 300 and a plurality of remote electronic devices 301A, 301B, 301C is provided. In the exemplified embodiment, the first electronic device 300 and the remote electronic devices 301A-C are each illustrated as iPhone's®. However, the invention is not to be so limited and each of the electronic devices 300, 301A-C can be any one of the different types of electronic devices discussed above. As can be seen, the first electronic device 300, which is operating as the stage, is in operable communication with each of the remote electronic devices 301A-C, which are operating as the players. This enables the first electronic device 300 to display a low resolution video (or other media) stream from each of the remote electronic devices 301A-C on its first display device 302. More specifically, utilizing the present invention described herein, the first electronic device 300 can display on its display screen 302 live low resolution video stream feeds of views that are perceived by camera lenses on the remote electronic devices 301A-C. The first electronic device 300 can then record video that is being perceived by the camera lenses of the remote electronic devices 301A-C. Finally, the invention enables a high resolution video clip to be transferred to the first electronic device to replace the low resolution video clip that is streamed during recording.

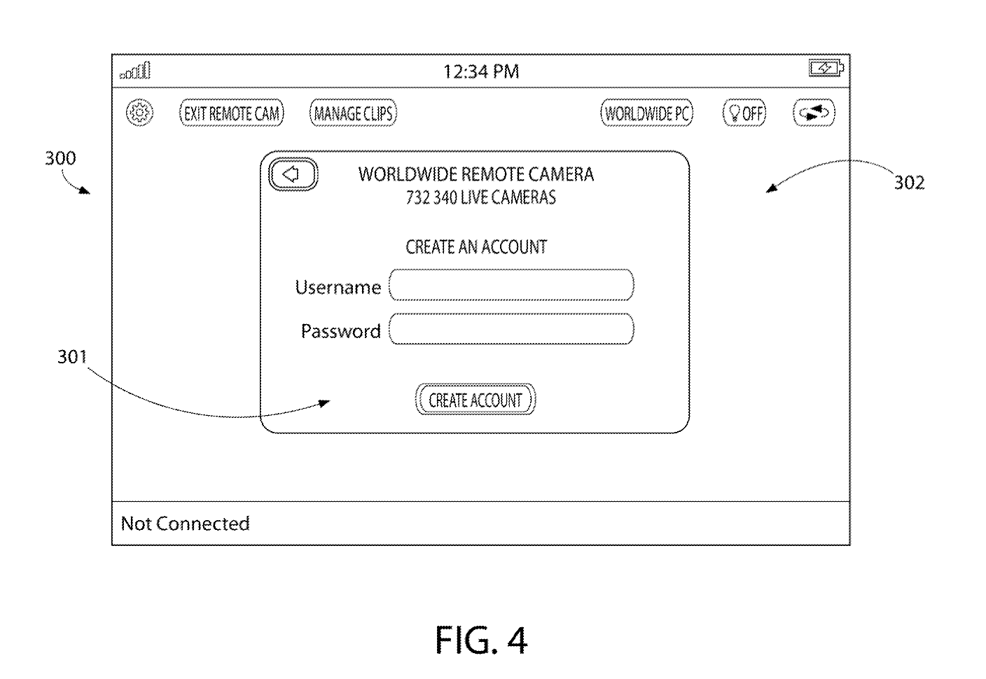

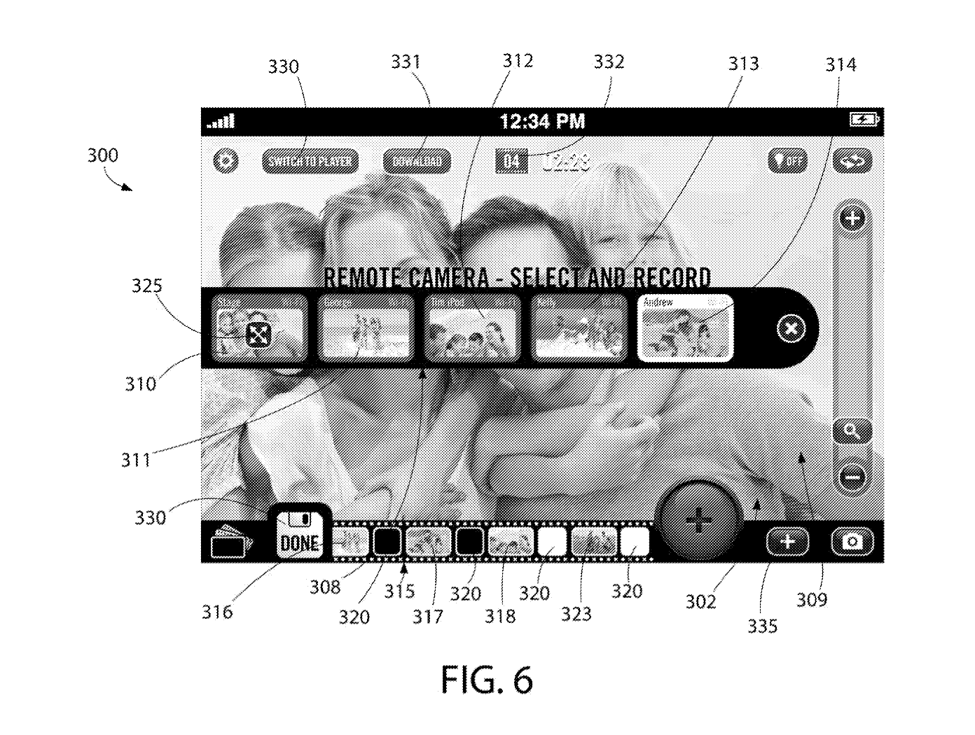

Referring now to FIGS. 4-6, a step-by-step discussion of the methods, techniques and operation of the present invention will be described. Referring first to FIG. 4, a screen shot of a login page of the present invention, which may be a mobile application, is illustrated on the first electronic device 300. It should be appreciated that in certain embodiments the login page may be omitted and upon launch, the application will go directly to the recording page such as that which is illustrated in FIG. 6. Thus, the login page is only used in some, but not all, embodiments of the present invention.

In embodiments that utilize the login page, upon a user downloading the inventive application onto the first electronic device 300, an application window 301 will appear on the first display device 302 of the first electronic device 300. In the application window 301, the user will be prompted to create an account by entering in a username and a password in the appropriate spaces on the application window 301. Prior to signing in or creating an account, the device is indicated as being “not connected,” as shown in the bottom left hand corner of the screen shot of FIG. 4. Furthermore, in the login page the user has the options to exit remote camera, manage clips, run worldwide remote camera, turn off flash, or reverse the camera direction as illustrated across the top of the first electronic device 300. The user can select any of these options using a user input means, which will be discussed below.

Upon creating an account, the user will be prompted to determine whether to be in a stage status or a player status via user input means on the first electronic device 300. The user input means on the first electronic device 300 can merely be a user using his or her finger to select between stage status and player status in response to a prompt (i.e., touch screen). However, the invention is not to be so limited and in other embodiments the user input means on the first electronic device 300) can be via a mouse utilizing click and point technology, a user pressing a button on a keyboard that is operably coupled to the first electronic device 300 (such as clicking the letter “S” for stage operation and “P” for player operation), or the incorporation of other buttons/toggle switches on the device. Any other technique can be used as the user input means on the first electronic device 300.

If the user selects to be in a player status, the camera view perceived by the camera lens of the first electronic device 300) will be available for viewing by other electronic devices that are in the stage status. If the user selects to be in the stage status, the camera views perceived by camera lenses of other remote electronic devices will be available for viewing by the first electronic device 300. In certain embodiments, the inventive application will automatically launch in the stage status, such that the user would then use the user input to opt out of the stage status and into the player status, as described in more detail below with reference to FIG. 6.

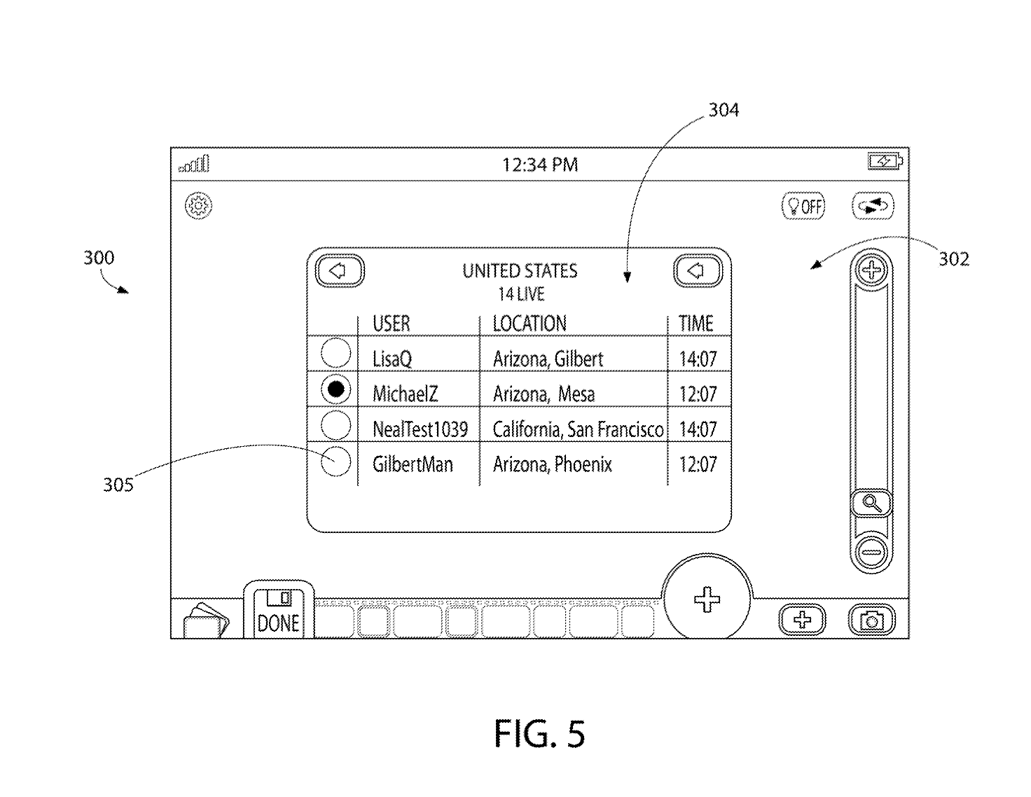

In certain embodiments, if the user selects to be in the stage status (or is automatically placed into such status), the first display device 302 of the first electronic device 300 will display a list of remote electronic devices that have initiated a sharing status, such as by logging into the application and initiating a player status via user input means on the remote electronic devices. FIG. 5 illustrates a screen shot of the first electronic device 300 with a list window 304 overlayed onto the first display device 302 of the electronic device 300. In certain embodiments the first display device 302 may display a camera view that is perceived by the camera lens of the first electronic device 300 and the list window 304 can be overlayed on top of the camera view display. As discussed above, in this embodiment the first electronic device 300 is acting as a stage. The user initiates the stage status via user input means on the electronic device 300. In certain embodiments, the first electronic device 300 that acts as the stage is referred to as the first electronic device while the electronic devices that are acting as players are referred to as the remote electronic devices, or the second electronic device.

In certain embodiments, the user does not need to select between stage status and player status. Rather, in certain embodiments upon launching the application, the list window 304 will be displayed on the first display device 302 of the first electronic device 300. In such embodiments, upon launch the application will automatically scan for remote electronic devices that are either active or that meet qualification criteria as discussed below. The user can then select various remote electronic devices to stream a low resolution video clip from, upon which action the first electronic device 300 is automatically deemed a stage. Alternatively, the user can not select any of the remote electronic devices and can instead proceed to use the camera on the first electronic device 300, upon which action the first electronic device 300 is automatically deemed a player. Furthermore, it should be appreciated that when the first electronic device 300 is operating as a stage, remote electronic devices can still stream video from the first electronic device 300. Thus, in certain embodiments upon achieving stage status, the first electronic device is both a stage and a player.

The list window 304 is a list of the remote electronic devices that have initiated a sharing/player status as indicated above. In certain embodiments that utilize the list window 304, every remote electronic device worldwide that is activated and that has entered a sharing status will be provided in the list. However, in other embodiments a remote electronic device will first have to meet one or more qualification criteria prior to being placed in the list window 304 on the first display device 302 of the first electronic device 300. The qualification criteria can be defined by the first electronic device 300 via user input means of the first electronic device 300. In certain embodiments, the one or more qualification criteria are selected from a group consisting of local area network connectivity, GPS radius from the first electronic device, location of the remote electronic device (i.e., desired geographical area), desired location (such as a particular venue, monument, stadium, etc.), and pre-defined group status. Still other qualification criteria can include weather conditions, such that remote electronic devices having similar weather conditions to the first electronic device 300 will populate the list window 304. Many other different criteria can be used as the qualification criteria to assist in determining which remote electronic devices should populate the list window 304 on the first electronic device 300. The different types of criteria that can be used as the qualification criteria is not to be limiting of the present invention in all embodiments unless so specified in the claims.

In other embodiments, the qualification criteria can be auto-extracted criteria. In such embodiments, the program automatically determines certain characteristics of the first electronic device 300, such as the weather, time, altitude, humidity, geographic location, surrounding landscape and the like. As a result, the program can automatically create matches for the first electronic device 300 by finding remote electronic devices that are located at locations with similar weather, time, altitude, humidity, geographic location or surrounding landscape. Thus, in certain embodiments the invention automatically looks for live players nearby or worldwide that match some environmental or situational criteria (either actual or as specified by the stage or stage user).

If the user uses the user input means and selects to view remote electronic devices based on local area network connectivity, the remote electronic devices provided in the list window 304 will be those that are connected to the same local area network as the first electronic device 300. If the user uses the user input means and selects to view remote electronic devices based on desired geographical area or location of the remote electronic device, the remote electronic devices provided in the list window 304 will be those that are located in the specified location. This can be accomplished utilizing GPS or other location finding means on the electronic devices. Alternatively, the user can select to populate in the list window 304 all remote electronic devices within a particular mile/kilometer radius from the first electronic device 300. Similarly, the user can select a desired location, such as a particular venue, monument, or stadium, and only view remote electronic devices on the list window 304 that are located at that particular desired location. In this manner, the first electronic device 300 will be able to record video or audio of a sporting event or concert that the user or owner of the first electronic device 300 is not even attending. Finally, the user can establish pre-defined groups, such as persons that the user is friends with, and can select to only have the remote electronic devices in those pre-defined groups portrayed in the list window 304.

In certain embodiments, a person may activate an electronic device as a stage and search for live players that are nearby. The present invention may match a live player that is located up the coast at the next beach, or at a beach 1,000 miles away in similar tropical, weather and sun conditions. The stage user may believe he is viewing live images that are nearby when in fact they are at quite a distance away. Features such as this maximize the number of live matches or usable match footage that can be incorporated into the user's video composition without requiring the stage user to manually search for live players at the beach at sunset or search the worldwide list of live players for those criteria. In certain embodiments, users can launch the stage mode and be presented with a reasonably manageable number of usable matches in describing order of relevance.

The list window 304 displays information about the various remote electronic devices to enable the user/owner of the first electronic device 300 to determine whether to view and/or record a low resolution video of the camera view (or audio or other media) being perceived by the camera lens (or microphone or other input component) of that particular remote electronic device. In the exemplified embodiment, the list window 304 illustrates the username, location by city and state, and current time at that location on the list window 304. In other embodiments, the location can be displayed on the list window 304 based on a particular venue name, GPS coordinates, or the like. Furthermore, the username can include the owner/operator of the particular remote electronic device's real name.

The remote electronic devices are displayed in the list window 304 in rows with a user selection box 305 next to each username. Using the user input means on the first electronic device 300, the user can select one or more of the remote electronic devices. The user selects a remote electronic device by clicking in the user selection box 305 (either via touch screen, mouse point/click techniques, keyboard, or the like). In certain embodiments, the user will click in the user selection box 305 of each desired remote electronic device from which the user wants to view a live feed of the camera view perceived by those remote electronic devices, and then provide an indication that the user has completed making selections. Upon adding all of the desired remote electronic devices, the user will use the user input to select the done button 307 to proceed to the next window.

In certain embodiments as discussed above, upon launching the inventive application the user will be brought directly to the recording page illustrated in FIG. 6. In such embodiments, the user will not be prompted to first select from the list window the remote electronic device(s) that the user desires to view camera views from. Rather, in such embodiments the inventive program will automatically match players (i.e., remote electronic devices) for the user of the electronic device 300, and will display the matched players as illustrated in FIG. 6 and discussed below. Thus, the inventive application can, in some embodiments, be programmed with algorithms that automatically select matches for a user. These matches can be based on any factors or characteristics that are discussed herein including environmental factors and qualification criteria that has been pre-set by a user.

In certain embodiments, a user activating as a player automatically enables stage users to record from that particular player's electronic device as discussed below. However, in other embodiments a stage will first request access to the player's camera view, and the player will be prompted to “allow” the stage access/connection to the player device.

In the exemplified embodiment, the list window 304 indicates that there are 14 live remote electronic devices from which the user can select to view the camera views perceived by those remote electronic devices. These 14 live remote electronic devices are either the devices that met the user's pre-selected qualification criteria, or they can be the remote electronic devices that meet auto-extracted criteria, or it can be a full list of all active remote electronic devices in the United States.

Referring to FIG. 6, a recording and editing page of the inventive application is illustrated on the first electronic device. As discussed above, in certain embodiments, upon launching the inventive application, the user is brought directly to the recording and editing page. However, in other embodiments the user will follow the steps described above and then be brought to the recording and editing page.

In the recording and editing page, the first display device 302 of the first electronic device 300 displays a first window 308 that overlays a primary window 309 of the first display device 302. In the exemplified embodiment, the primary window 309 displays the first camera view that is perceived by a first camera lens of the first electronic device 300. Of course, in embodiments wherein the media is not video, the primary window 309 displays a low resolution media stream (which can be audio, still photograph, text, graphics, etc) of the remote electronic device. The media can either be being perceived currently by the remote electronically device, or it can be pre-stored media and the remote electronic device can simply be a library database (described in more detail below). Furthermore, in other embodiments the pre-stored media can be computer-generated, such as a pre-stored media file saved on a server. However, the invention includes a swap function that, upon being activated, displays one of the remote camera views in the primary window 309.

The first window 308 that overlays the primary window 309 displays the plurality of remote camera views perceived by the camera lenses of the remote electronic devices that were selected from the list as discussed above with reference to FIG. 5 as well as the first camera view that is perceived by the first camera lens of the first electronic device 300. In embodiments whereby the selection stage is omitted, the first window 308 displays the plurality of remote camera views perceived by the camera lenses of the remote electronic devices as determined by the inventive program's matching algorithms.

Specifically, in the exemplified embodiment the first window 308 displays the first camera view of the first electronic device 300 in a first thumbnail 310 of the first window 308, a first remote camera view of a first remote electronic device in a second thumbnail 311 of the first window 308, a second remote camera view of a second remote electronic device in a third thumbnail 312 of the first window 308, a third remote camera view of a third remote electronic device in a fourth thumbnail 313 of the first window 308, and a fourth remote camera view of a fourth remote electronic device in a fifth thumbnail 314 of the first window 308. Of course, more or less than four remote camera views can be displayed in the first window 308 depending upon the number of remote cameras/users that are selected from the list window 304 as discussed above. As noted above, upon a swap function being activated, such as by user input on the user input means, a selected one of the remote camera views can be displayed in the primary window 309 and in its respective thumbnail. Furthermore, as has been discussed herein, although the invention is being described herein directed to camera views, in other embodiments whereby the media is other than video/photograph, the camera views are omitted and it can be any other media perceived by a remote electronic device.

In the exemplified embodiment, each of the thumbnails 310-314 displays a low resolution media stream of the high resolution media clips indicative of the camera view that is perceived by the lens of the particular electronic device. Initially, until activation and recordation are initiated as discussed below, the low resolution video stream of the high resolution media clips indicative of the camera view is merely displayed on the thumbnails 310-314 for the user to preview, but is not recorded or saved into the memory of the first electronic device 300. In the exemplified embodiment, the first thumbnail 310 depicts a low resolution video stream of the high resolution media clip indicative of the first camera view that is perceived by the first camera lens of the first electronic device 300. The first thumbnail 310 may depict the low resolution video stream of the high resolution media clip indicative of the first camera view regardless of whether the first electronic device 300 is set in a recording mode or not. Thus, in certain embodiments even if the first electronic device 300 is not set to record, the first camera view perceived by the first camera lens of the first electronic device 300 will be displayed as a low resolution video stream in the first thumbnail 310. Similarly, the second thumbnail 311 depicts a low resolution video stream of a high resolution media clip indicative of the first remote camera view that is perceived by the camera lens of the first remote camera. The second thumbnail 311 may depict the low resolution video clip of the high resolution media clip indicative of the first remote camera view regardless of whether the first remote camera is set in a recording mode or not. The same is true for each of the third, fourth and fifth thumbnails 312-314 in displaying the low resolution video clip of the respective high resolution media clips that are indicative of the remote camera views. Of course, the low resolution video stream can merely be a low resolution media stream, which includes audio, photography, graphics, text, or the like.

In certain embodiments, upon the remote cameras that are chosen to be players being selected (such as from the list window 304 or automatically as determined by the inventive application, as discussed above), the thumbnails 310-314 are all selected. The user can deselect any of one or more of the thumbnails 310-314 by using the user input, such as by tapping on the respective thumbnail 310-314, double tapping on the respective thumbnail 310-314, sliding a finger across the respective thumbnail 310-314, or the like. Furthermore, in other embodiments upon the remote cameras that are chosen to be players being selected, none of the thumbnails 310-314 are selected and the user uses the user input means discussed above to select those thumbnails.

In the exemplified embodiment, each of the first, second, third and fourth thumbnails 310-313 have been selected as discussed above. As a result, each of the first, second, third and fourth thumbnails 310-313 are darkened/grayscaled. However, the fifth thumbnail 314 has not been selected (or has been deselected), and thus the fifth thumbnail 314 remains white. The particular coloring/grayscale used is not limiting of the present invention, but it is merely a perceivable difference in the colors or other visible features of the thumbnails that indicates to the user which of the camera views is being recorded. In the exemplified embodiment, the low resolution video streams of the high resolution media clips indicative of the first camera view of the first electronic device 300, the first remote camera view of the first remote electronic device, the second remote camera view of the second remote electronic device, and the third remote camera view of the third remote electronic device are available for use in a video composition that is to be created as discussed above. However, the low resolution video stream of the high resolution media clip indicative of the fourth camera view of the fourth remote electronic device is merely being displayed in the fifth thumbnail 314, but is not also being stored in the memory device of the first electronic device 300. However, it should be understood that in the exemplified embodiment, the low resolution media streams of the high resolution media clips of each of the first, second, third and fourth remote camera views are all displayed and streamed on the thumbnail, regardless of whether or not they are selected.

In the exemplified embodiment, the thumbnails 310-314 are displaying low resolution media streams of high resolution media clips of the camera views of the remote electronic devices (and of the first electronic device in the first thumbnail 310). However, the invention is not to be so limited. The thumbnails 310-314 may merely be visual indicia of each of the low resolution video streams. Thus, the visual indicia may be a username, a person's actual name, a location of the electronic device by GPS coordinates, venue name, city and state or the like or any other type of visual indicia of the remote electronic devices and the first electronic device. In still other embodiments, the visual indicia may be a blank thumbnail that is colored. Thus, in certain embodiments there is nothing actually streaming on the thumbnails 310-314, but the thumbnails 310 merely represent an electronic device by being visual indicia.

As discussed above, the present invention is not limited to video as the media being streamed, recorded and edited. Thus, in embodiments whereby the media is audio, still photos, text, graphics, music and the like, there would be no low resolution video stream to display on the thumbnails 310-314. In such embodiments, the visual indicia noted above can be used. In the case where the media is audio only, if users double-taps on that particular colored proxy thumbnail to make it active, having headphones attached, the user could hear the audio from that particular device.

In the exemplified embodiment, while the low resolution video streams of the first camera view and the remote camera views are being displayed on the thumbnails 310-314 of the first window 308 (or in alternative embodiments, while the visual indicia is displayed on the thumbnails 310-314), the user can use the user input means to activate recordation of those low resolution video streams. Specifically, upon clicking on the record button 320, the first electronic device 300 will begin recording into its memory device an extended low resolution video (or other media) clip from the first electronic device 300 and each of the remote electronic devices that it has a low resolution video stream or other visual indicia displayed on one of the selected thumbnails 310-313. Thus, in the exemplified embodiment, upon the user clicking or tapping on the record button 320, the first electronic device 300 will record into its memory an extended low resolution video clip of the high resolution media clips indicative of the camera views of the first electronic device 300, the first remote electronic device, the second remote electronic device and the third remote electronic device. Because the fourth remote electronic device has been deselected (i.e., the fifth thumbnail 314 is white), the low resolution video clip of the high resolution media clip indicative of the camera view of the fourth remote electronic device will not be recorded and saved in the memory of the first electronic device 300.

In the manner discussed above, the extended low resolution video clips of the high resolution video clips of the camera views from each of several different electronic devices, including both the first electronic device 300 and several remote electronic devices, can be recorded into the memory of the first electronic device 300 at the same time, each saved as a separate file. In addition to recording the extended low resolution clips of the high resolution video clips of the camera views of the electronic devices separately, the user can also use the inventive application to create and record into the memory of the first electronic device 300 a single interim video composition that is a combination of separate low resolution media clip segments from each of the extended low resolution video clips recorded as discussed below.

During the recording process, the video composition that is being created is referred to herein as an interim video (or media) composition. After completion of recording, the video composition is referred to herein as a final video (or media) composition. It will be better understood from the description below that the interim video composition is a composition that includes low resolution video (or media) and the final video composition is a composition that includes high resolution video (or media).

In the exemplified embodiment, prior to pressing the record button 320, the user will activate one or more of the thumbnails 310-314 such that the activated thumbnails (or the activated low resolution video streams) will be recorded as a specific temporal portion of a video composition. Although the invention is described as activating the thumbnails, it should be appreciated that at certain points the invention is described as activating the low resolution media streams or other visual indicia which are depicted on the thumbnails. The thumbnails are indicators, in certain instances, of the low resolution media streams. Thus, when a particular thumbnail is activated, the low resolution media stream or other visual indicia that corresponds with that particular thumbnail is also considered activated.

In the exemplified embodiment, the first thumbnail 310 has been activated, as indicated by the activation symbol 325 displayed on the first thumbnail 310. Activating the thumbnails 310-314 can be achieved by clicking or tapping on the thumbnails 310-314, double, triple, quadruple (or more) tapping on the thumbnails 310-314, sliding the user's finger downwardly, upwardly, sideways or the like across the thumbnail 310-314 or by any other user input means. Thus, in addition to separately recording the extended low resolution video clips of the high resolution video clips of the camera views of each of the first electronic device 300 and the remote electronic devices, the first electronic device 300 also records to memory an interim video composition that is created by switching back and forth among and between the various low resolution video clips or camera views.

Thus, in the exemplified embodiment the first four thumbnails 310-313 are selected so that upon pressing the record button 320 the extended low resolution video clips corresponding to the camera views of the first electronic device and the first, second and third remote electronic devices will be recorded to the memory of the first electronic device 300 as discussed above. Furthermore, in the exemplified embodiment the fifth thumbnail 314 is deselected so that upon pressing the record button 320 the camera view of the fourth remote electronic device will not be recorded to the memory of the first electronic device. Because the fifth thumbnail 314 is deselected, the fifth thumbnail and what it represents (i.e., the camera view of the fourth remote electronic device) is unavailable for inclusion in the video composition. However, in certain embodiments the deselected thumbnail can be later selected even during a recording session. Specifically, in the exemplified embodiment the user can press, tap or otherwise engage an addition button 335 which enables a user to add a new thumbnail/electronic device into the recording session. Thus, the user can click the addition button 335, and then tap or click the fifth thumbnail 314 to include the low resolution video stream of the camera view of the fourth remote electronic device into the recording session so that the camera view of the fourth remote electronic device is available for use in the interim video composition.

In the exemplified embodiment the activation symbol 325 is displayed on the first thumbnail 310 so that the first electronic device 300 is activated for inclusion in the first temporal portion of the video composition. Thus, in the exemplified embodiment, upon pressing the record button 320, the interim video composition will begin being recorded to the memory of the first electronic device 300 with a low resolution media clip segment of the low resolution media stream corresponding to the camera view of the first electronic device 300 because the first thumbnail 310 corresponding to the first electronic device 300 is activated. At some time after pressing the record button 320, for example ten seconds after pressing the record button 320, the user can deactivate the first thumbnail 310 (such as by single, double, triple or the like tapping the first thumbnail 310 or by any other user input means discussed above) and activate the second thumbnail 311 (or the third thumbnail 312 or the fourth thumbnail 313) using any of the user input means discussed herein. At this point, the activation symbol 325 will no longer be displayed in the first thumbnail 310, but will instead be displayed in the second thumbnail 311 (or the third thumbnail 312 or the fourth thumbnail 313). Thus, starting at ten seconds after recording began, the interim video composition will be recorded to the memory of the first electronic device 300 with a low resolution media clip segment of the low resolution media stream corresponding to the camera view of the first remote electronic device (or the second remote electronic device or the third remote electronic device, depending upon which of the thumbnails is activated). The user can continue activating and deactivating the various thumbnails so that different low resolution media clip segments from the different electronic devices are included in the video composition at different temporal points thereof.

Using this technique, the user can switch between the different remote camera views by activating and deactivating the various respective thumbnails. For example, if a one minute video composition is being created, the user will tap the record button 320 and all of the low resolution video streams corresponding to the selected thumbnails will be recorded in the memory device of the first electronic device. In the exemplified embodiment, there are three remote electronic devices that are selected (and the first electronic device is selected). At the end of the one minute recording, all of the one-minute extended high resolution media clips (one from each of the remote electronic devices that are selected) are transmitted to the first electronic device 300 and stored in the memory. However, those three one-minute extended high resolution media clips are also combined into a final video composition with the live switching timing decisions that were made during the recording as discussed above. Thus, the final video composition that is created is an edited video that is one minute long, but that switches between the various selected camera views as often as the user desired, for instance twenty times or more, throughout the one-minute.

Thus, in certain embodiments the video composition can be created by the user on the fly during recordation of the various low resolution video clips. Specifically, the user of the first electronic device 300 can switch between the various low resolution media streams that are being recorded and activate a specific one of the various low resolution video streams being recorded to be used in the video composition at a specific moment in time. As one example, the user may be standing on a specific street corner in Paris and can initiate a stage session. The user may find that there are three live players on a street corner in Paris near the user. The user can select all three players and activate a record. However, in addition to recording three separate expanded low resolution video clips from each of the three players, the user can activate only one of the three players at a time to record from for the creation of the video composition. Thus, the user can switch back and forth between the three players to obtain various different views from the street corner in Paris. After one minute or any other desired time, the user can use the user input means to stop recording by clicking the done button 320. Upon completion of recording, the one-minute (or other desired time) high resolution video clip will be transmitted to the memory device of the first electronic device 300. In this example the one-minute high resolution video clip will be a combination of the different camera views from the three different players at different temporal portions throughout the video clip. This negates the need for any later editing and creates a desired scene or video compilation automatically.

Although the invention has been described above such that only one of the selected thumbnails 310-313 is activated at a time, the invention is not to be so limited in all embodiments. In certain embodiments, more than one of the selected thumbnails 310-313 can be activated and have the activation symbol 325 displayed thereon at a single time. As a result, the low resolution media clip segments from more than one of the camera views will be included in the interim video composition at the same temporal point in time of the interim video composition. With video, this can be accomplished by utilizing picture in picture or split screen views on the interim video composition. With audio, this can be used to achieve a stereo or surround sound effect such that if audio at a concert is being recorded from different vantage points, the combined sound when all are activated and recorded to create a media composition, a surround sound effect is achieved. In other words, if multiple remote electronic devices are located at a concert venue at different locations, a stage can record from each of the players at the same time and can activate each of the players at the same time as discussed above. Thus, when the media composition that includes the sound from each of the players together at the same point in time in the media composition is replayed, the sound will be equivalent to a surround sound.

If the first and second thumbnails 310, 311 corresponding to the low resolution media stream of the first electronic device 300 and to the low resolution media stream of the first remote electronic device are activated sequentially during recording, the low resolution medial clip segment of the low resolution media stream of the first electronic device and the low resolution media clip segment of the low resolution media stream of the first remote electronic device will be positioned sequentially in the interim media composition. If the first and second thumbnails 310, 311 corresponding to the low resolution media stream of the first electronic device 300 and to the low resolution media stream of the first remote electronic device are activated concurrently during recording, the low resolution media clip segment of the low resolution media stream of the first electronic device and the low resolution media clip segment of the low resolution media stream of the first remote electronic device will be positioned concurrently in the interim media composition. Concurrent positioning can be achieved as discussed above by using picture in picture or split screen when the media is video, or by concurrent audio to achieve a surround sound effect when the media is sound/audio.

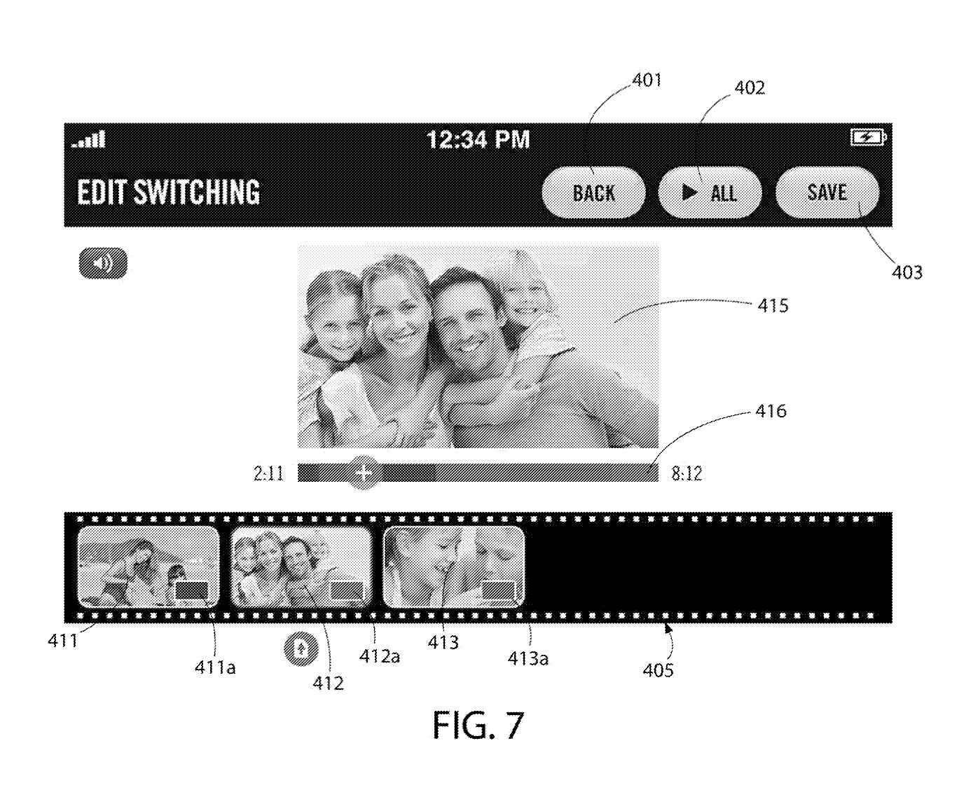

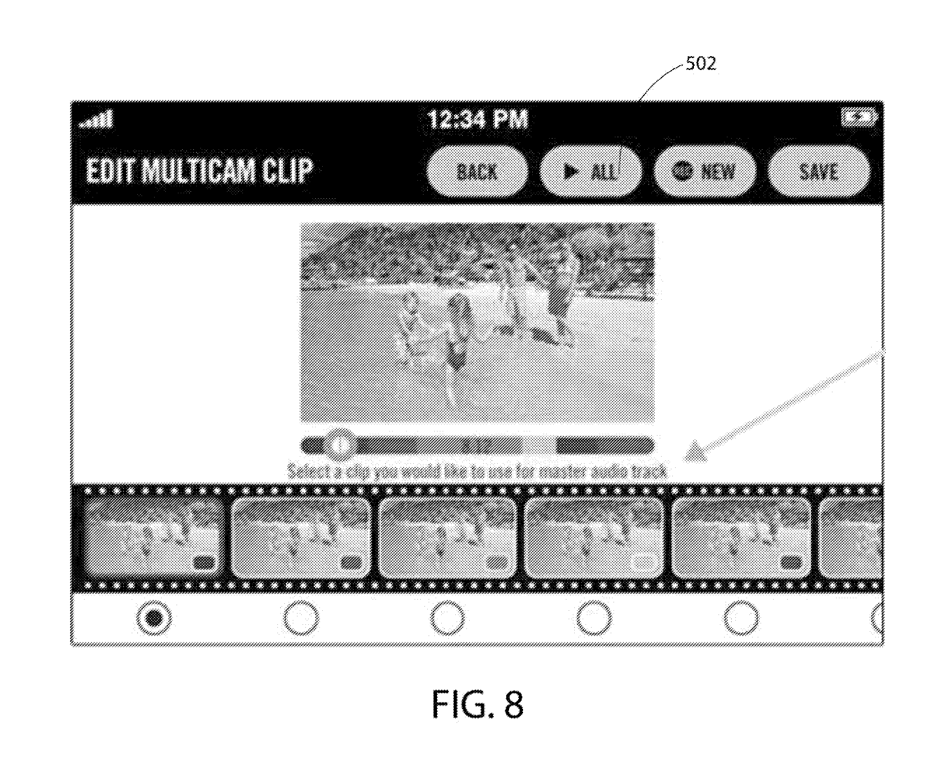

Referring still to FIG. 6, upon the user determining that the interim video composition is complete, such as after recording for five minutes, the user will use the user input to select (tap, click, etc.) the done button 330. This will signal completion of recording of the separate expanded low resolution media clips from each of the electronic devices corresponding to one of the selected thumbnails and completion of recording of the interim video composition. Upon tapping the done button 330, the first electronic device 300 will have stored in its memory an extended low resolution media clip (that comprises the low resolution media clip segments) corresponding to the high resolution media clips of the camera views (or the audio sounds perceived by) the electronic devices that were selected as discussed above. The extended low resolution media clip of each of the camera views will have a length in time equal to the time between the user tapping the record button 320 and the user tapping the done button 330 (as long as the thumbnail corresponding to the camera view was selected during that entire time period). Additionally and separately, the memory of the first electronic device 300 will also have stored an interim video composition corresponding to the various low resolution media clip segments that correspond to the thumbnails that were activated at different points in time during the recording session. This interim video composition is essentially a video composition that has been edited “on the fly” during the recording of the various electronic devices. Thus, the interim video composition is a completely edited video composition that needs no further editing (although further editing is possible if desired, as discussed below with reference to FIGS. 7 and 8. The interim video composition includes various segments of time (sequentially or simultaneously such as picture in picture and split views as discussed above) from different camera views from different remote electronic devices compiled into a single video.

By only streaming and recording low resolution images of the remote electronic devices onto the display and into the memory of the first electronic device 300, the present invention overcomes packet drop issues that occur when attempting to stream higher resolution clips or situations when an electronic device may lose connection altogether. This allows for live, non-linear recording from one electronic device by another.

Moreover, for each thumbnail or low resolution media stream that is selected as discussed above, a high resolution media clip of the remote camera view of that remote electronic device is being recorded and stored on the remote electronic device capturing or perceiving that remote camera view. Thus, for example, as noted above the first remote camera view of the first remote electronic device is selected and thus an extended low resolution media clip of the first remote camera view is both being displayed in the second thumbnail 311 and being stored and recorded into the memory device of the first electronic device 300. At the same time, an extended high resolution media clip of the first remote camera view is being recorded and stored on the first remote electronic device. Similarly, the second remote camera view of the second remote electronic device is selected and thus an extended low resolution media clip of the second remote camera view is both being displayed in the third thumbnail 313 and being stored and recorded in the memory device of the first electronic device 300. At the same time, an extended high resolution media clip of the second remote camera view is being recorded and stored on the second remote electronic device.

Furthermore, the same thing occurs with the activated thumbnails that correspond to low resolution media streams. Specifically, during the creation of the video or media composition, when one of the thumbnails is activated, a low resolution media clip segment of the camera view perceived by the electronic device corresponding to the activated thumbnail is recorded into the memory of the first electronic device 300. At the same time, a high resolution media clip segment corresponding to the low resolution media clip segment is recorded and stored on the remote electronic device capturing or perceiving that remote camera view. It should be appreciated that the high resolution media clip segment is identical to the low resolution media clip segment except the high resolution media clip segment has a higher resolution than the low resolution media clip segment. Thus, the terms high resolution and low resolution are not intended to be limiting of the present invention, but rather are merely used as terms to be understood relative to one another to indicate one resolution that is higher than another resolution.

In certain embodiments, one or more of the thumbnails on the display of the first electronic device 300 can be used as a proxy (i.e., placeholder) for a later-added media. Specifically, in such embodiments the thumbnails will be used as visual indicia for a plurality of electronic media recording devices. Upon initiating recording, a perceived event will be recorded on each of the electronic media recording devices. The media clip will contain an electronic media recording device identifier. This will enable the media clip to be later incorporated into a media composition. The user will selectively activate the visual indicia of the plurality of electronic media devices to generate and record a proxy clip segment in an interim video composition on the first memory device. Each proxy clip segment is associated with the electronic media recording device whose visual indicia was activated to generate that proxy clip segment. Furthermore, each proxy clip segment is associated with a temporal period.

In such an embodiment, the proxy clip segment is a blank media segment, which can simply be a buzz, silence, a blue screen or any other type of media segment. The proxy clip segment is used as a placeholder so that the media clips recorded on the electronic media recording devices can be later added to the media composition. This can be useful if the electronic media recording devices can not operably electronically communicate with the first electronic device, but can later be connected thereto or if the media clips can later be downloaded thereon.

Then, for each proxy clip segment recorded in the interim media composition, the first electronic device will receive the media clip that was recorded on the electronic media recording devices. Furthermore, for each media clip received, the media clip will be matched with the corresponding proxy clip segment based on the electronic media recording device identifier. A segment of the media clip that corresponds to the temporal period of that proxy clip segment can then be extracted and automatically used to replace the proxy clip segment, thereby creating a final media composition comprising the media clip segments.

At some point in time after the user has clicked the done button 330 to indicate completion of recording, the extended high resolution video clip that is recorded on the respective remote electronic devices is transmitted to the first electronic device 300. Thus, an extended high resolution video clip corresponding to each one of the extended low resolution video clips that were saved locally on the memory of the first electronic device 300 is transmitted to the first electronic device 300. Upon receipt of the extended high resolution video clips by the first electronic device 300, the extended high resolution video clips replace the extended low resolution video clips in the memory of the first electronic device 300. The replacement of the extended low resolution video clips with the extended high resolution video clips in the memory of the first electronic device 300 occurs automatically upon the first electronic device 300 receiving the extended high resolution video clips from the remote electronic devices.

Similarly, after the user has clicked the done button 330 to indicate completion of recording, for each low resolution media clip segment recorded in the interim media composition, the first electronic device receives a high resolution media clip segment from the remote electronic device that corresponds to that low resolution media clip segment. Furthermore, the inventive application automatically replaces the low resolution media clip segments in the interim media composition with the high resolution media clip segments to create the final media composition comprising the high resolution media clips. In certain embodiments, the interim media composition and the final media composition are the same singular file.

As discussed above, the high resolution media clip segments and the extended high resolution media clips are transmitted from the remote electronic devices to the first electronic device at some time after the user clicks the done button 330 to indicate completion of recording. This later time can be determined in a number of ways. Specifically, in some embodiments the extended high resolution media clips and the high resolution media clip segments of the remote camera views are automatically transmitted to the first electronic device upon the user clicking the done button. The extended high resolution media clips transmitted to the first electronic device 300 will be temporally delimited by the time that the user began recording the extended low resolution media clips and the time the user ended recording of the low resolution media clips.

In other embodiments, the extended high resolution media clips and the high resolution media clip segments can be transmitted to the first electronic device 300 upon determining that the extended high resolution media clips and the high resolution media clip segments will be transmitted at a data rate that exceeds a predetermined threshold. Thus, it may be determined that upon the user ending recording, the data rate is too slow for transmission of the extended high resolution media clips and the high resolution media clip segments. In such instances, the remote electronic device will wait until the data rate exceeds the predetermined threshold, and at such time will transmit the extended high resolution media clips and the high resolution media clip segments. In still other embodiments, transmitting the extended high resolution media clips and the high resolution media clip segments from the remote electronic devices to the first electronic device 300 can be automatically initiated upon determining that the first electronic device 300 is no longer recording.

In certain embodiments, transmitting the extended high resolution media clips and the high resolution media clip segments of the remote camera views from the remote electronic devices to the first electronic device 300 includes wirelessly uploading the extended high resolution media clips and the high resolution media clip segments of the remote camera views from the respective remote electronic devices to the server, and wirelessly downloading the extended high resolution media clips and the high resolution media clip segments of the remote camera views from the server to the first electronic device 300. Furthermore, in some instances uploading the extended high resolution media clips and the high resolution media clip segments to the server is automatically initiated upon determining that the extended high resolution media clips and the high resolution media clip segments of the respective remote camera views will be wirelessly uploaded from the respective remote electronic devices to the server at a data rate that exceeds a predetermined threshold. Similarly, in some instances downloading the extended high resolution media clips and the high resolution media clip segments from the server is automatically initiated upon determining that the extended high resolution media clips and the high resolution media clip segments of the respective remote camera views will be wirelessly downloaded from the server to the first electronic device 300 at a data rate that exceeds a predetermined threshold.

As discussed above, upon the extended high resolution media clips of the remote camera views from the respective remote electronic devices being transmitted to and received by the first electronic device 300, the extended high resolution media clips replace the extended low resolution media clips for that remote camera view that were recorded/stored in the first memory device of the first electronic device 300. Furthermore, the high resolution media clip segments are combined together to form the final media composition and replace the interim media composition which comprises the low resolution media clip segments. In certain embodiments, the high resolution video clip is transmitted/routed through a server as has been discussed in more detail above.

In certain embodiments, after the extended high resolution media clips corresponding to the extended low resolution media clips are stored in the memory of the first electronic device, the inventive application extracts the high resolution media clip segments that correspond to the low resolution media clip segments of the interim media composition from the extended high resolution media clips stored/recorded on the memory device of the first electronic device. Then, the inventive application replaces the low resolution media clip segments of the interim media composition with the extracted high resolution media clip segments.

Upon being created, the video composition is stored in the memory of the first electronic device. In one embodiment, the video composition can be stored as a single file. In other embodiments, each of the separate high resolution video clips that are used to form a single video composition is saved as separate files, such as in the same folder or subfolder. In yet another embodiment, each of the separate high resolution video clips that are used to form a single video composition is given metadata that effectively defines the video composition, such as associating each unique high resolution video clip with a unique video composition identifier that defines the unique high resolution video clips as being a part of a particular video composition and a position identifier that defines the sequential ordering of that particular video clip in the video composition.

In another embodiment, starting with frame 00:00:01, the software takes one frame at a time from each live camera or stored camera file (whichever camera(s) appear at that frame, there could be more than one camera in a given frame as in case of Picture-In-Picture) and creates a new frame or a composite frame and writes those frames in sequence to a new digital file that is sometimes referred to as a flattened file because it no longer has multiple layers that can be edited. So for a one-minute final flattened movie at 30 frames per second, this process of accessing the folder of related files and grabbing the needed frames and creating a new composite frame happens 1,800 times. The 1,800 frames are then saved as a single movie file which could contain substantial text (not visible) meta data about each camera or each frame. The same process occurs with audio, photos, text, time overlays and the like.

In certain embodiments, the low resolution video clip stored in the memory device of the first electronic device can be replaced with a completely unrelated high resolution clip that was shot with a different, completely disconnected camera that was shooting at the same time. This can be accomplished by manual file replacement.

The first display device 302 of the first electronic device 300 also has a switch to player icon 330, a download icon 331 and a number of recorded players icon 332. Upon selecting the switch to player icon 330, the first electronic device 300 is taken out of stage mode and entered into player mode such that the first electronic device 300 can no longer view and record camera views from remote electronic devices. As discussed above, in certain embodiments that application automatically launches in stage mode, so selecting the switch to player icon 330 may be the only mechanism by which the first electronic device 300 can be put into player mode in some embodiments. The download icon 331 enables the user to download desired video clips. The number of recorded players icon 332 provides the user with an indication of the number of camera views from various electronic devices, including the first electronic device 300 and any remote electronic devices, that is currently being recorded.

In the exemplified embodiment, the first display device 302 of the first electronic device 300 comprises a second window 315. In certain embodiments, the second window 315 is displayed on the display device 302 of the first electronic device 300 simultaneously with the first window 308. However, the second window 315 may only be displayed at certain times, such as after completion of a recording session.

After the first electronic device 300 receives the final media composition and stores it in its memory device, a graphical representation 316 of the final media composition is displayed in the second window 315. As discussed above, the final media composition is a complete video that comprises various media segments obtained from several different electronic devices. If recorded correctly or in a desired manner the first time around, no further editing will be required. However, if the final media composition is not exactly as the user desires based on timing of the different media clip segments in the final media composition, the user can edit the final media composition by user input via the first user input means, such as by tapping or clicking on the graphical representation 316 in the second window 315. The editing feature will be described in more detail below with reference to FIGS. 7 and 8.

If the user desires to add additional media to the second window 315, the user can click the addition button 335. Clicking the addition button 335 will enable the user to start a new recording session or add media that is already downloaded onto the first electronic device 300 into the second window 315. Pushing or clicking the addition button 335 may bring up a menu screen to enable the user to select what it is he desires to do. In certain embodiments, prior to starting a new recording session or adding other media to the second window 315, the user may desire to add a transition so that when all of the media compositions and other media in the second window are played in succession, there are transitions (fade out, fade in, white screen, black screen, etc.) in between each separate media composition or other media file. Transitions are identified by transition graphics 320.

In the exemplified embodiment, the second window 315 has graphical representations 317, 318, 323 indicative of several media compositions and other media files as well as transition graphics 320 that are saved to the memory of the first electronic device 300. Each of the media compositions or other media files is represented by a different graphical representation 317, 318, 323 that is indicative of that particular media composition or file.

As discussed above, in certain embodiments it may be desirable for a user to edit a final media composition after it has been received and stored in the memory of the first electronic device 300. The user may view the final media composition and determine that the camera switching was not on the timing sequence as desired, or that the audio in the composition is not loud enough or is otherwise deficient. The user can edit the final media composition by user input via the first user input means (i.e., clicking/tapping, double clicking/tapping, sliding finger along the graphical representation 316, or the like).

Upon double clicking the graphical representation 316 or otherwise indicating that the user desires to edit the final media composition, the inventive application will bring up an edit switching page, which is illustrated in FIG. 7. In the edit switching page, the user can modify the final video composition. Specifically, the edit switching page has a back button 401, a play all button 402, and a save button 403. Furthermore, the edit switching page has an expanded high resolution media clip window 405. Within the expanded high resolution media clip window 405 are graphical representations of each of the expanded high resolution media clips that are included in the particular final media composition being edited. For example, if during the initial recording stage discussed above with reference to FIG. 6 the user activated three different thumbnails (correlating to three different remote electronic devices) at different times during the recording session, the final video composition would include high resolution media clip segments from each of the three remote electronic devices. However, in order to enable the user to edit the final media composition, the expanded high resolution media clip window 405 will include the entire expanded high resolution media clip that was recorded and saved in the memory of the first electronic device 300 from each of the three remote electronic devices. Thus, in the exemplified embodiment the expanded high resolution media clip window 405 includes a first graphical representation 411 of a first expanded high resolution media clip that was recorded from a first remote electronic device, a second graphical representation 412 of a second expanded high resolution media clip that was recorded form a second remote electronic device, and a third graphical representation 413 of a third expanded high resolution media clip that was recorded from a third electronic device. Each of the expanded high resolution media clips is limited in length by the time the user hit the record button 320 and the done button 330 (as long as each of the thumbnails corresponding to the first, second and third remote electronic devices was selected when the user hit the record button 320 and the end button 330).

The user can edit the final video composition by tapping or clicking the play all button 402. This will begin to play each of the first, second and third expanded high resolution media clips simultaneously. The user will then also activate one or more of the first, second and third expanded high resolution media clips (by tapping or clicking on one of the first, second or third graphical representations 411-413) so that only the activated expanded high resolution media clips are included in the edited video composition 415 at a particular time during the video. Thus, the editing feature is similar to the initial recording feature. Each of the first, second and third graphical representations also includes a visual indicator (411a, 412a, 413a). In the exemplified embodiment, each of the visual indicators 411a, 412a, 413a is a different colored box. Of course, other visual indicators can be used.

Furthermore, the edited video composition 415 includes a timing bar 416 that indicates the length in time of the edited video composition 415. The timing bar 416 is colored along it to indicate which of the first, second and third expanded high resolution media clips is in the edited video composition 415 at a particular time. Upon completing creation of the edited video composition 415, the user can click/tap the save button to save the edited video composition 415 in the memory device of the first electronic device 300.

Referring to FIG. 7B, in addition to editing the video aspect of a final media composition, a user can also edit the audio. Specifically, certain media compositions include both video and audio. Thus, using the screen in FIG. 7B, the user can select the audio from a particular electronic device to be incorporated into the final/edited media composition along with video from a different electronic device. In this screen, all of the expanded high resolution media clips are again provided. The user can click the play all button 502 to start playing all of the expanded high resolution media clips simultaneously. The user can then select (by checking the circle as exemplified or clicking on the thumbnail, etc.) which of the expanded high resolution media clips should be playing audio at a particular moment in time in the final or edited media composition. In certain embodiments, more than one of the expanded high resolution media clips can play audio in the final/edited media composition. Specifically, a first one of the expanded high resolution media clips can play the left audio, a second one of the expanded high resolution media clips can play the right audio, and a third one of the expanded high resolution media clips can be playing the video. Thus, any of the various expanded high resolution media clips and its various components (i.e., audio and media) can be used to create different portions of the final or edited video composition.

In certain embodiments, it may be found that a user logs into the application using his or her first electronic device 300 as a stage, and that there are no remote electronic devices logged in as players that meet the user's criteria at a particular time. Thus, in certain aspects the invention may include a library feature that includes a library database of pre-recorded videos or audio files that can emulate remote cameras on the server. In certain embodiments, each player (i.e., each electronic device) can have a library database of pre-recorded videos or audio files stored thereon. Each of the pre-recorded videos and audio files will have descriptive meta data about their original capture (i.e., the original recording of that particular file) that match specified or current live criteria so that the stage user (i.e., the user of the first electronic device 300) is potentially not even aware that the pre-recorded videos are not live. For example, the following criteria may be used to determine if a pre-recorded video or audio file located in the library, which may be on the server, could match a stage user's specified or live criteria: current weather, current time, relative time in terms of sun position, compass direction, temperature, altitude, audio waveform, light meter reading, white balance temperature, contrast of shadows to highlights, humidity, air quality, nearby water temperature and quality, wind speed and direction, season, types of plant and other life nearby or detected, moon phase, general mood detected, gas price, economic and health indicators, per capita income, object recognition such as cars or bicycles or building types detected, population density, traffic volume, nearby transportation methods, facial cues, color similarities, fashion styles. The inventive application can auto-extract data about the user's current environment and compare it with the meta data from the pre-recorded files in the library.

In certain embodiments, the library database may include media files that were pre-recorded by electronic devices. However, in other embodiments the library database may include computer generated media files that are generated to emulate a live player or remote electronic device. The media files in the library database can be stored in the server and include all criteria needed to match actual live footage. For example, a computer could generate a pre-recorded media (video) file that is a three-dimensional rendering of Times Square in New York City. If a user enters stage mode and searches for players, the computer generated pre-recorded media file of Times Square can populate on the user's electronic device. The server or computer may be able to generate a media file on the fly in order to match a particular user's live current conditions. Thus, if the user is in Times Square and it is snowing, the computer may be able to generate a three-dimensional rendering of Times Square with snow falling. As a result, the user in the stage mode will not be able to decipher that the computer generated file is not live footage from a live player/electronic device nearby. Thus, the computer/server can create a media file to match a user's current environment to mimic a live camera (or other electronic device).

Alternatively, using pre-recorded media files that were actually pre-recorded from another live electronic device, these pre-recorded media files can also mimic a user's current conditions. Specifically, User 1 may record Times Square on Day 1 and that recording will be stored in the library database. User 2 may enter as a stage in Times Square on Day 2 (i.e., the following day). Even if there are no live players on Day 2, the pre-recording from User 1 from the previous day can be used to populate the user's player list, and the user may not realize that the pre-recording is not live. Thus, the players or remote electronic devices described herein throughout can be live electronic devices that are actually currently active, pre-recorded media that were actually recorded by live electronic devices at a previous time, or computer generated media that are either previously created and stored, or created while the user is active as a stage in order to mimic the user's environment.

Thus, in certain embodiments the space and time continuum are irrelevant so that live or virtual real-time multicamera sessions can be created by broadcasting files that are archived in the library and stored on the server. The archived files are used to emulate live players. As one example, on Jul. 10, 2013 in Central Park, there may be only 2 active players recording between 10:00 am to 10:15 am. In 2014 on the same date and time there may be seven active players recording. However, in 2014 the two active players from 2013 will be saved and archived in the library as pre-recorded video files, and will be presented to a stage in 2014 along with the seven active players. Thus, the stage users in 2014 at Central Park on July 10 between 10:00 am and 10:15 am will think that there are nine users. By the year 2020, there will potentially be hundreds of matching video/audio/still photo files from over the years that a user could switch to in creating a video composition. Furthermore, the invention is not limited to only utilizing pre-recorded video/audio files that are at the same time and place. Rather, pre-recorded video/audio files from that recorded in other parks around the world at different dates and times that match the environmental conditions, weather conditions and other qualification criteria and are likely to be undetectably realistic live matches to stages actual or defined shooting scenario.

Thus, the invention may automatically determine which pre-recorded audio and video files match the user's current conditions. For example, the user may be standing in a blizzard, and the present invention can locate pre-recorded video files that were taken during similar blizzard conditions. In certain instances, the pre-recorded video file can be at the same location during a blizzard that occurred years earlier, but the user of the stage or first electronic device 300 may be unaware that the video file he is viewing is pre-recorded and not live.

If the stage user selects as a player one of the pre-recorded video clips, a low resolution video stream of the pre-recorded video clip will be presented in the thumbnails as discussed above. Then, if the user activates recording of the pre-recorded video clip, the low resolution video clip will be recorded onto the memory of the stage. Then, for each low resolution video clip recorded on the memory of the stage, a corresponding high resolution clip will be transmitted from the library database to the stage to automatically replace the low resolution video clip. Thus, the pre-recorded video clips operate exactly as the live players, and the communication between the stage and the library database (whether it be on the server or elsewhere) is exactly the same as the communication between the stage and the live players.

In certain embodiments, the stage's location and other data can be emulated or falsified in order to obtain live players that match a criteria, even if the criteria is different than the stage's current situation. For example, a user could launch the inventive application in San Diego and type into a search query for qualification criteria: “I am standing on a street corner in Paris at 7 pm in December and it is snowing.” If it is currently 7 pm in December in Paris and snowing, live cameras from Paris would show for selection. If no live cameras/players match the criteria of the search query, emulated live players (i.e., pre-recorded video files) matching the criteria would present for user selection. Also, the user could be filming themselves in front of a Green Screen in their home and could launch the inventive application as a stage and type (or say) the search query: “I am standing in Times Square at sunset on a warm summer day facing north with the wind to my back.” If the current conditions in New York match that search query, live players in New York would be presented on the stage device for selection. If there are no matches, emulated live players (i.e., pre-recorded video files) would be presented for selection.

The idea in both live stage mode and emulated stage mode is that users do not have to search for players or stick footage by keyword. Rather, the inventive application automatically detects the environment of the stage, or the user defines an environment and the inventive application presents all video, photos, audio and etc that match so the user can can “live-switch” to that source while creating a video composition in real-time.

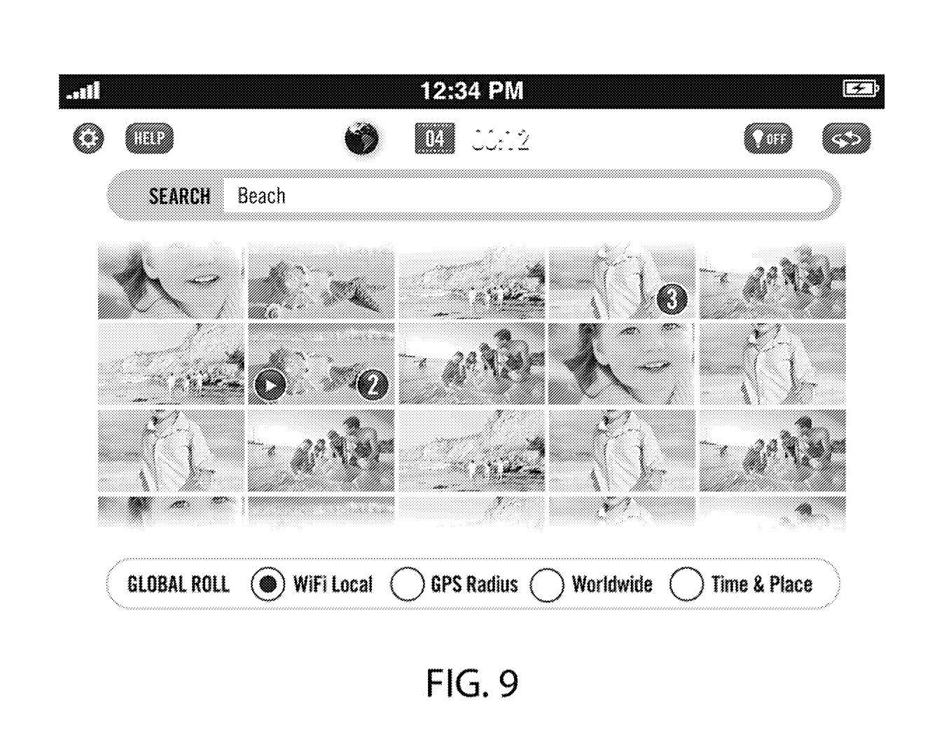

Referring to FIG. 9, a screen shot illustrating a searching tool for locating video clips based on qualification criteria. As discussed above, in certain embodiments a user may request that a list of players be provided that match a specific criteria. The user may submit the request either by typing into a query box as illustrated in FIG. 9, using voice detection software built into the device, or any other technique. In the exemplified embodiment, the user has typed in a search for “Beach” and representative images of video files that were taken at the beach are displayed for user selection. The video files displayed may be only live players, only pre-recorded video files, or a combination of live players and pre-recorded video files. In certain embodiments, the inventive system is programmed to first look for and provide the user of the stage with a list of live players that are nearby or worldwide that match some environmental or situational criteria. However, if there are not enough live players, or if the user wants more options, the pre-recorded video files can be provided to the user. The user can select the pre-recorded video files and stream the low resolution video clips from them in the same manner as with the live players discussed above. Furthermore, high resolution video clips are transmitted corresponding to the low resolution video clips in the same manner for both the live players and the pre-recorded video files.

In certain embodiments, the user can simultaneously stream video from both live players (i.e., actual electronic devices that are concurrently operating the inventive application) and pre-recorded library files. In this manner, video compositions can be created that are a combination of live video feed and pre-recorded video feed.

Many permutations and variations can be accomplished in view of the above, some of which are described below. In certain embodiments, the present invention can be used to trigger recording on a second device (or a third device thru proxy player as discussed above) via Bluetooth or Infrared or sound or light or other mechanism or even to manually trigger recording on the camera. In such instances, the stage would only show a temporary blank proxy that can be used for switching and then the user would replace that blank proxy with the disk file or would transcode from tape or other means and replace that proxy file either by time stamp manual sync or audio waveform or clapboard sync. This technique can be used if: (1) an older camera is being used; (2) a camera that does not have WiFi or HDMI out is being used; or (3) when the user cannot afford an additional mobile or streaming device. This allows any media recording device (photos, videos or sound, etc) to participate in a multi camera session and the blank proxy on stage can be manually labeled with an indicator such as “1985 Sony Betacam” or “8-track recording console.”

In certain embodiments, the invention enables the faithful reproduction of left/right stereo sound, multi-channel surround sound or follow sound by automatically detecting via GPS and Compass or manually via user input the spatial arrangement of all cameras and audio recording devices in the session. In other words, if there is a concert and the user switches to a camera close to the stage, it may be advantageous via GPS to identify active players in the session or in the vicinity on the left side of the stage and right side of the stage at time of recording. Rather than using stereo audio from the center stage camera mic, the present invention would use left stage camera audio for left stereo channel and right stage camera audio for right stereo channel in the final movie. In cases of 7-channel surround sound, the inventive application can pull audio from 7 different devices to create the stereo audio track (via auto or manual mixing) or the true multi-channel Dolby Digital or THX surround audio.

Although the invention has been described whereby the full high resolution video clip (or audio clip or the like) is transferred from each device at a specified time, this is not required in all embodiments. In some embodiments only the portion of a specific clip that is actually used in a live edit switching session is transferred. This will speed up file transfers and increase efficiency of the same. In such embodiments, the full length files can be added back into the package at a later time to expand editability.

### EXAMPLES

The following paragraphs further describe the various embodiments of the invention with detailed explanations or examples in everyday language to assist the reader.

### 1. Automatic or Manual Clip Replacement

The replacement of low-resolution or proxy placeholder clips from remote media recording devices with their related high-resolution files can happen either automatically at end of recording when the files transfer or can happen manually at some other time. In other words, if a user acting as the stage is recording from the camera or microphone on his or her own device while at the same time remotely recording from a 2^{nd} device acting as a player, a low-res version of the 2^{nd} camera feed is being transferred while recording. When the stage user stops recording, the high-resolution file from the 2^{nd} device can be automatically transferred to the stage in which case the low res file would be automatically replaced or both users could decide to defer the transfer or it may not be possible to transfer at that time and so the stage user could manually replace the low-res file with the high-res file at a later time or through other means.

Either the stage or the player can defer transfer of high-res until a later time for example if the high-res transfer would take too long or perhaps either device needs to record something else immediately. In cases where only a proxy placeholder is used on the stage because the low-res live feed is either technologically unavailable or because of network bandwidth constraints, once the high-res file has been copied onto the stage users device, the stage user would select the proxy placeholder and manually import the high-res file as a replacement.

It is also possible to replace the low-res or proxy placeholder clip with a completely unrelated high-res clip that was shot at the same time with a different (completely disconnected) camera by this manual file replacement process outlined above. One example of this might be that you have an old video camcorder that only records to tape and does not have any sort of preview output or Wi-Fi connectivity. In this case, the stage user can either define a proxy placeholder thumbnail on the stage or an iPhone could be mounted to the front of the camcorder acting as a temporary player preview. At the end of recording, the high-res from the iPhone would be transferred to the stage but then once the tape from the old camcorder is digitized into an electronic file, the stage user could replace that proxy placeholder or temporary player preview with the desired camcorder footage. All switch edits done to the proxy or temporary preview would be applied to this new camcorder file automatically so that no manual editing would be required in the creation of the final multi-camera composition. In fact, any file in the composition can be replaced with any other file even if not related by time or place. It would take on the original files edit timing.

### 2. Player Acting as a Bridge for a 3^{rd} Device Camera

In the case when the player is acting a bridge for an external camera device over Wi-Fi, there are actually three resolutions. The low-resolution proxy, the high-resolution final recording and the original super-high resolution file recorded locally on the camera.

In other words . . . imagine a RED ONE 4K cinema camera connected to an HTTP Streaming device, that device is connected on its input side to the RED ONE 4K via its HDMI preview output and is connected on its output side to the player device via Wi-Fi. When stage triggers record, it sends a message to the player and instead of (or in addition to) recording its own camera input, the player sends a message to the streaming device to begin recording the live preview feed from the RED 4K camera.

The streaming device also sends a message to the RED 4K camera to begin recording on its own hard drive in 4× HD resolution or higher. While the stage is recording, the streaming device is sending low-res stream or proxy thumbnails to the player and the player acting as a bridge is sending the same to the stage.

When the stage stops recording, it sends a message to player to stop and player sends a message to the Wi-Fi streaming device to stop recording and send the high-res HD or SD file to the player and player sends to stage. However, at a later time, the HD high-res can be replaced with the 4× HD that was recorded locally on the RED ONE hard disk (via time data) to create Cinema quality final movies.

In another example, a stage user wants to record from three iPhone cameras, two iPod Touch devices with microphone input only and a GoPro Hero 3 Camera. The problem with the GoPro Hero 3 camera is that although it has internal Wi-Fi, it only creates an ad-hoc network. An ad-hoc network means it creates its only little Wi-Fi network that one electronic device can connect to but it is not capable of connecting to a broad WiFi network. This works fine if there is only one stage device that wants to record its camera feed and the GoPro camera feed over Wi-Fi at the same time but if other devices need to be included in the session, this does not work. So what happens in this case is the Go-Pro Hero 3 is connected to what the present invention call an offline-player over the GoPro's Ad-Hoc network. Then the stage user taps the + button and adds a Proxy Player to the session which might show up as a solid colored rectangle with a label they define like “Go Pro Hero 3”. During the recording session, the stage user might switch back and forth between the three iPhones and sometimes choose the GoPro proxy to be the active camera. The stage might choose one or more of the microphones to be the audio the entire time. At the end of recording, the Player would receive from the GoPro the medium-res file and the Player would change its Wi-Fi network from the GoPro's Ad-Hoc network to the Wi-Fi network that the stage is connected to. Then the Player would automatically or manually be detected by stage and would transfer the medium-resolution file from the GoPro to the stage. However, the user could also extract the media card from the GoPro and connect it to the stage device and import the full high-resolution clip recorded locally on the GoPro during the session and replace the proxy or medium resolution clip with that final file. Again, no editing would be required. Sync between the proxy and high res could happen automatically via audio waveform matching or manually by user.

It is also possible to trigger recording on a second device (or a third device thru proxy player) via Bluetooth or Infrared or sound or light or other mechanism or even to manually trigger recording on the camera and stage would only show a temp blank proxy that can be used for switching and then user would replace that blank proxy with the disk file or would transcode from tape or other means and replace that proxy file either by time stamp manual sync or audio waveform or clapboard sync.

This may be used when utilizing an older camera or a camera that does not have Wi-Fi or HDMI out or when user cannot afford an additional mobile device or streaming device. This method of manual transfer is often referred to as sneakernet. This allows ANY media recording device (photos, videos or sound, etc.) to participate in a multi camera session and to be eligible for live edit decisions. The blank proxy on stage can be manually labeled like 1985 Sony Betacam or 8-track recording console.

### 3. Multi-Device Stereo Sound Reproduction

The invention enables the faithful reproduction of left/right stereo sound, multi-channel surround sound or follow-sound by automatically detecting via GPS and Compass or manually via user input the spatial arrangement of all cameras and audio recording devices in the session. In other words, if there is a concert and user switches to a media input device close to the stage, it may be advantageous via GPS to identify active players in the session or in the vicinity on the left side of the stage and right side of the stage at time of recording. Rather than using stereo audio from the center stage microphone, the stage could automatically use the device located on stage left audio for left stereo channel and device located stage right for right stereo channel in the final movie. Stage user could also manually define this mix of audio input devices before recording or while recording and could switch audio sources separately from switching visual sources. In cases of 7-channel surround sound, the stage could pull audio from 7 different devices to create the stereo audio track (via auto or manual mixing) or the true multi-channel Dolby Digital or THX surround audio.

### 4. Various Criteria can be Used to Automatically or Manually Present Available Remote Media Devices to Stage

For example, someone might be making a movie in on the beach at sunset and scans for live players nearby but none are found, so the invention can automatically match to a live player up the coast at the next beach or perhaps 1,000 miles away in similar tropical and weather and sun conditions. Although the stage user can elect to manually scan for available remote media capture devices, or can elect to search by keyword or other criteria and choose from a list, one goal is to eliminate as many steps as possible. When the stage user activates their session, the preferred method is to automatically connect to relevant remote devices and present them with pre-selected thumbnails for each of those devices so that they can just tap record and begin live switch editing. They can deselect auto-connected and selected devices, search for other devices and etc. but the present invention aims to achieve the fewest steps possible.

One objective is to maximize the number of possible usable remote media capture devices that can be incorporated into the users movie without them having to manually search for live players at the beach at sunset or search the global roll for those criteria. User should just be able to launch the stage, and be presented with a reasonably manageable number of useable matches in describing order of match relevance.

### 5. Automatic Scan, Connect, Select and Record

The most extreme simplification of the process is where the stage is configured to auto-record on launch or on power-up. In other words, stage user only has to launch or activate their device and available remote devices are automatically identified, connected and selected and record starts automatically on all devices, then user taps stop record and all high-res files are transferred and combined into the final edited composition. In this case, user does not have to scan, does not have to select players, and does not even have to tap record. Of course the present invention gives them controls in settings to take back control of each of these areas but many will opt for the most automatic operation possible.

### 6. The Difference Between Scanning, Selecting and Switching

Scanning is the process where a stage user scans the network or the community for currently available remote media recording devices. The stage user might also scan the entire registered community for on-call devices or all devices. In the case of on-call or all community devices, the stage can send a direct request or a request through the community server that will send a push notification, email, text message or other notification to all users in hopes that some will choose to become active and available quickly. Once they become active, they would automatically appear in the stages remote player list or thumbnails view or stage could receive a notification and decide to add them manually. Just because a remote device shows up in a list after scanning does not mean it is selected for the session.

Selecting is when the stage user decides to include that remote media capture device in the currently recording session. This process of selecting happens automatically by default to save the user steps but the user can change that in settings so that after they see the list or thumbnail views of all available remote devices, they would have to manually select each one to make it part of the session.

Switching can happen before or during recording or edit review. In other words, after scanning, 5 devices might automatically be selected on stage for inclusion in the session or stage user might manually select 5 devices. Once all devices have been selected for inclusion, and before recording the system automatically makes at least one of those devices ACTIVE for the purpose of the composition. The thumbnail view or list could show 9 available devices but only 5 of those being selected indicated by a red border around them. A cross-x icon might indicate the ACTIVE device(s) among the selected devices. An unselected device cannot be ACTIVE. In some use cases, more than one device might be active for video and separate devices active for audio. User can make active more than one audio, photo or video source at one time for example for Picture in Picture, split screen or stereo audio.

### 7. Emulated Remote Media Recording Devices

One important aspect of the invention is to emulate remote cameras on the server or on player devices using pre-recorded media files having descriptive meta data about their original capture that match specified or current live criteria so that the stage user is potentially not even aware that those players (cameras) are not live. For example, in number 8 that follows titled Comprehensive Meta Data for Player Matching and Search, the present invention defines some of the criteria may be user to determine if a Pre-Recorded File located on the server could match stage users specified or live criteria.

For example, they can restrict to local Wi-Fi only or to a certain GPS area radius. They can also search by keyword such as “beach sunset” or by scenario using a natural language query such as “I am standing on a street corner in Paris at 4 pm on a rainy day in November”. This would be converted to a database query used to match live players, emulated live players or archived media. User could select those to add to a multi-camera session or simply select to load the archived clip.

One problem with stock media is that let's say you find three 10 minute clips of a rainy afternoon street scene in Paris near the same corner but from different angles, currently you would have to download all three entire clips, which could take 20 minutes each and then you have to insert those clips into your editing timeline and try to trim each down to the 8 seconds you want to use of each. If you want to switch back and forth between them, it becomes much more complex because you have to duplicate the clips and position and trim each duplicate to try to simulate live switching back and forth. This would take a LOT of time.

By contrast, in the present invention, if you standing on a street corner in Paris and initiate a stage session and there are three live players on a street corner in the rain in Paris right now near you, you can select all three players and hit the start record button and switch back and forth between them for one minute and hit stop, the present invention only transfer the 1-minute from each player when done recording. No editing, no post work, just real-time editing and the movie is done.

Now, let's say there are no live players available and you still want a multi-camera effect for your movie. Well, if over the last two years, 30 people have stood near that same corner in Paris while it was raining and contributed those clips to the live wall or global roll. The present invention would automatically present those 30 to you as live players (you wouldn't know the difference) but our server would be emulating a live person recording live. Because most scenes in same weather at same time of day are indistinguishable, you wouldn't be able to tell the difference between a live or emulated live player. Now, why is this important? Because in the current process, as explained above, you would have to download each full length archived clip and perform a lot of editing to simulate a multi-camera session. By contrast, in our invention, you just select 3 of the “playing” emulated live camera angles and start recording. You then switch back and forth between each emulated live player (10-15 minute archived clips playing on server) and when you hit stop one minute later, the emulated live server players transfer the high res of that 1 minute section only, no editing, no trimming. All happens live and in real time.

The present invention essentially turns every piece of media ever recorded into a million live broadcasting rerun television stations. When you go live as a stage, the present invention first look for live players nearby or worldwide that match some environmental or situational criteria (either actual or specified by stage), but, if not enough truly live players are found or user wants more options, the present invention show them the live stations (emulated players playing reruns of live sessions) that match the criteria, environment or situation so they can choose those and live switch between them while creating their movie. This eliminates the need to search through stock media, play each result all the way thru, download each full length media file, import each file into a timeline, duplicate each for each time you switch to it and trim each duplicate to simulate a live multi-camera switching session.

### 8. Comprehensive Meta Data for Player Matching and Search

Today, most stock photography is only indexed by keyword. This is extremely limiting. An important aspect of our invention that makes it work so well is the method in which the present invention capture and infer additional information about the device or the recorded file. For example, current weather, current time, relative time in terms of sun position, compass direction, temperature, altitude, audio waveform, light meter reading, white balance temperature, contrast of shadows to highlights, humidity, air quality, nearby water temperature and quality, wind speed and direction, season, types of plant and other life nearby or detected, moon phase, general mood detected, gas price, economic and health indicators, per capita income, object recognition such as cars or bicycles or building types detected, population density, traffic volume, nearby transportation methods, facial cues, color similarities, fashion styles. It is not required that all of this data be available for each and every remote device or recorded file but when it is, it will make it that much easier to successfully and intelligently auto-select live and emulated-live players.

Cases in point, currently users can search stock libraries by keyword but not typically by time of day or date shot. Let alone searching for footage where the camera was pointed west at 5 pm and sun was at 36 degree angle to field of view and it there was light rain in an urban area with population density of 400 per square block and wind speed of 10 degrees south by southwest. It is easy to see how valuable both tagging and searching by all of that info would make it much easier to find matching, usable footage and is an important aspect of the invention.

### 9. Emulated Stage Environment

Stage users location and other data can be emulated too. User could launch the app in San Diego and type in “I am standing on a street corner in Paris at 7 pm in December and it is snowing” and then, if it is currently 7 pm in December in Paris and snowing, live cameras would show for selection, if not, emulated live cameras matching the criteria would show. Also, user could be filming themselves in front of a Green Screen in their home and could launch stage and type or say “I am standing in Times Square at sunset on a warm summer day facing north with the wind to my back” and if those are current conditions in New York, live players would show, if not emulated live players would show.

The idea in both live stage mode and emulated stage mode is that users do NOT have to search for players or stick footage by keyword, the present invention detect your environment or you define one and the present invention take care if the rest to show you all video, photos, audio and etc that match so you can “live-switch” to that source while you are creating your movie in real-time. Lots of people will record just audio for this (think sound of subway station at rush hour) and entire sessions and movies could be audio only like if user is creating a radio story.

### 10. Multiclip Package Explained

When stage stops recording a one-minute multi-device session, it receives from each device the full one-minute media clip so that they can edit the switching decisions later. A multi-clip package is created containing everything and that can be shared with the players or others so they can create their own live switch mix.

### 11. Edit Switching Explained and File Transfer Options

The edit switching window recreates the original live recording by playing all players while you re-switch between them as you would have if you had been stage while recording live. Essentially each file plays back as an emulated live player so that you can edit the live switching decisions using the same methodology. It is like a rerun of the original session that you can live-switch again.

However, although the present invention can transfer the full high-resolution file from each device, that is not required in the invention. In some cases it may be advantageous and expedient to only transfer the portion(s) actually used in the live edit switching session. Although this would restrict the stages ability to re-switch or re-edit, it would make file transfers much faster and more efficient. At a later time, the full-length file could be added back into the package to expand the edit-ability. This is especially important in the case of emulated live players and the previous mentioned jukebox example (below) where stage would only want to get the high/res portions used from each.

### 12. At Least Three Modes of Recording

There are at least three modes of operation or recording, Sequential Mode, Switching mode and Multi-Take Switching Mode. In sequential mode, when the stage taps each player in the preview, it is just so they can see each camera larger, at the end the three 1-minute, high-res recordings are transferred to stage and placed in sequential order in the timeline. The final movie would be 3 minutes long repeating the same event 3 times. In switching mode, when stage is tapping a player clip in the preview, they are making a live switching edit decision (i.e. show this camera at this moment in time), at the end of recording, the present invention still send all 3 one-minute high res recordings but then those are combined in a multi-clip package with the live switching timing decisions and an edited composited movie is created that is one minute long for a one minute event but might switch between each of the thee cameras 20 times. This package allows the stage user or anyone else (if stage shares the package) to recreate the live moment and play back all cameras at same time and live switch between them or just manually edit to create a new final movie 1 minute in length. This package can also be converted into a sequential sequence or a combination of switching and sequential. There is also a third type that is important in filmmaking. It's called a multi-take, switching mode. In this mode, you may want to combine the concepts of sequential and switching when you are recreating a scene many times (multiple takes) as in when a director is filming a 1-minute scene where two people are having a scripted argument and says “take two, take three, take four” and so on. If the director uses 4 cameras on each 1-minute take and time synchs each recreation of the event with a clapboard, then he would be able to not only live switch and post-edit switch between each camera in a single take but be able to switch between all 16 cameras across the four takes to create the perfect movie. This goes back to the core of our invention not being tied to the typical concept of time and place when talking about live recording and live switching.

### 13. Multi-Clip Package Vs Final Flat Composition

In practice, what actually happens is that starting with frame 00:00:01, the software takes one frame at a time from each live camera or stored camera file (whichever camera(s) appear at that frame, remember could be more than one as in case of Picture-In-Picture) and creates a new frame or a composite frame and writes those frames in sequence to a new digital file that is sometimes referred to as a flattened file because it no longer has multiple layers that can be edited. So for a one-minute final flattened movie at 30 frames per second, this process of accessing the folder of related files and grabbing the needed frames and creating a new composite frame happens 1,800 times. The 1,800 frames are then saves as a single movie file, which could contain substantial text (not visible) Meta data about each camera or each frame. This also happens with audio, photos, text, time overlays and etc.

### 14. Stages can Double as Players

A stage device can also double as a player device for another stage and a player can also act as a stage. For example, a stage user may want to connect to 8 other remote media recording devices and perform live switches between those devices and his or her own local device. But another stage in the same area also may want to record the remote media feed of that that first stage device in its' own composition with other unrelated player devices. In other words, when the stage scans and selects player devices, it may or may not select it's own device for the recording session but it can also at the same time make its own device available to other stages as a player. In this case, the stage would be recording its own device locally and recording the low res from all of its connected players onto its device while at the same time transmitting a low-res version of its own feed to one or more separate stages. The recording times could differ. The stage might start its own recording composition at 8:31 pm and finish at 8:33 pm whereas the 2^{nd} stage might start recording at 8:32 pm and finish at 8:35 pm. In this case, the stage is capable of automatically splitting up its own recording into the two necessary pieces, one for its' own composition and one for the 2^{nd} stages composition. At the end of the 2^{nd} stages recording session, it would request the high-res file from first stage and first stage would send that high res file as if it were a player.

### 15. Players can Serve Multiple Stages

There will be times when more than one stage user desires to connect to and remote record from to a single player at the same time. For example, in a concert, there might be only one camera up on stage and every stage in the audience would love to include that camera in their composition the entire duration of the concert. In this case, all stages could connect to and select that same single player. The player device would keep track of these connections and would either send low-res feeds to each, broadcast one low-res feed that all could receive or, if bandwidth limits, could be represented on each stage as a blank proxy thumbnail. The player would always record anytime any stage is actively recording and the player would keep track of these various connections and various start and stop times sending each stage the necessary piece of the full recording on its device that corresponds to that stages recent session or these transfers could be postponed until after the concert is over at which point each stage would request and the player would send the necessary pieces of the various recordings required for their compositions.

### 16. Everyone can be a Stage and a Player at the Same Time

The invention is not limited to a single stage connecting in a single direction to multiple players. Although that may be a common scenario, the invention and the systems involved also allow for multiple stages connected to the same players, multiple players acting as stages connected to each other in both directions as player and stage and single players connected to more than one stage. For example, there are situations such as a wedding where every user present would like to be a stage but would also like to make their device available as a player as well. In this case, 8 friends could all connect to each other as both stages and players so that they could all perform their own live switch in real-time including only the devices they want to include and excluding others. In this case, each player will have to be constantly recording from the time the first stage sends a record command until the time the last stage sends a stop command. Then the stages would request or the players would send each connected stage the portion of the longer recording that corresponds to that stages start and stop time. Likewise, that player would be able to request from all other stage/players the portions of the files they need for their compositions.

### 17. Use Case Example

### Live Switching Music Audio on Multiple Player Devices to a Multiple Stage Devices to Create a Multidevice Music Jukebox

Let's say that 20 people using our app are at a bar and instead of using their devices to contribute to an edited composite, visual presentation, they want to contribute to an audio presentation (again the patent should make it clear that the invention makes no distinction between different types of media files, still photos, video, text, graphics, audio, music).

Each player could play a song or sequence of songs from their internal or cloud-based music library and the stage acting as the DJ or Mix-Tape maker would receive medium resolution quality audio from each and could automatically or manually live switch between them (perhaps with a dissolve near the end of each song) and the stage's audio output could be connected to a sound system that would play the live-mix for everyone in the bar. At the end of the session, each player would either transfer the entire high-resolution audio music file session or just the songs used to the stage for the creation of a full quality, high-resolution mix tape edit that could be shared with others or as a multi-clip package that could be edited.

### 18. Use Case Example

### Stereo Audio Recording Using Two or More Connected Devices

Stage device connects to one or more nearby player devices at a concert and taps record and can hear low quality reference mix audio through headphones and then taps stop and player transfers the high quality audio from second device to be mixed with audio from first device to automatically create a true stereo (two mic) or surround sound (7 mic) audio file.

### 19. Use Case Example

### Time Synced Slide Show

10 users at a birthday party connect to each other as simultaneous stages and players for the purpose of creating a single still photo slideshow of the event. As each user snaps a photo, each of the 9 other users receive a low res proxy to be added to their timeline. At the end of the event, each user can scroll thru their timeline and delete any unwanted images and then tap receive and all devices would send their high-res photos to each of the other devices or to an intermediate server for distribution to each device. The end result would be a finished, customized photo slideshow of the birthday party in time sequence order using the desired contributions of all 10 cameras.

### 20. Use Case Example

### Remote Microphone

Stage user connects to one or more devices for the purpose of recording a single camera video that contains video from one device and synced audio from other separate devices. For example, in a hurricane, a lone reporter may set up as a player, a single mobile device camera on a car dashboard shooting video out of the window while the reporter is standing outside of the car in the rain and wind at a distance but within the cameras view holding a second mobile device to their mouth as a microphone. When they tap record on the stage (microphone) device, the video from player device would replace audio on stage device and create a single angle camera video with a single mono audio track on stage that combines video from the player and audio from the stage.

### 21. Use Case Example

### Multi-Camera Recording

Stage device sends out a request for players at a surfing contest to an intermediate server or over Wi-Fi. All nearby players receive a push notification to join the live session. Those that join automatically appear as thumbnails on stage. Stage selects one or more to record from including but not necessarily its own camera. Then taps record. Player devices send low res proxy thumbnails or streaming video to stage and stage either manually or automatically switches between each device while recording to create an edited, switched composition. When stage user taps stop, each player device sends high resolution file to stage immediately or at a later time. Stage then generates a multiclip package consisting of all of the receives high resolution video and audio and photo files (and proxies for those not yet received) as well as the player details, environmental details and other meta data and the live switching decision edit details and also creates a final edited movie. The final edited movie and the multiclip package is then automatically or manually sent to all participating players so that they can change the editing or change the switch timing or eliminate some clips in the multiclip package and create their own new edited movie to share.

### 22. Use Case Example

### Multi-Camera Recording Using Both Live and Emulated Live Players (Meta Data Encoded Archived Stock Media being Played and Broadcast from a Central Server or Player Devices to Emulate Live Players

One component of the invention is that the system ignores the space and time continuums allowing us to emulate live or even create impossible virtual real-time live multi-camera sessions by broadcasting archives files as emulated live players. On Jul. 10, 2013 in Central Park, there may be only 2 active players recording at 10 am to 10:15 am, in 2014 on same date and time there may be 7, but the present invention will replay those first two from 2013 (if weather matches) so that users think there are 9, by 2020, the present invention could have hundreds of matching cameras from over the years that a user could switch to in their movie. But the present invention don't have to be limited to same time and place, the present invention could also show cameras that recorded at 11 am on July 15th each year or cameras that recorded in other parks around the world at different dates and times that match the environmental, weather conditions and other criteria and are likely to be undetectably realistic live matches to stages actual or defined shooting scenario.

Let's say there are no live players available and you still want a multi-camera effect for your movie. Well, if over the last two years, 30 people have stood near that same corner in Paris while it was raining and contributed those clips to the live wall or global roll. The present invention would automatically present those 30 to you as live players (you wouldn't know the difference) but our server would be emulating a live person recording live. Because most scenes in same weather at same time of day are indistinguishable, you wouldn't be able to tell the difference between a live or emulated live player. Now, why is this important? Because in the current process, as explained above, you would have to download each full length archived clip and perform a lot of editing to simulate a multi-camera session. By contrast, in our invention, you just select 3 of the “playing” emulated live camera angles and start recording. You then switch back and forth between each emulated live player (10-15 minute archived clips playing on server) and when you hit stop one minute later, the emulated live server players transfer the high res of that 1 minute section only, no editing, no trimming. All happens live and in real time.

### 23. Use Case Example

### Audio Only Multi-Device Session for Mix Tape Recording

On a bus equipped with Wi-Fi or using Bluetooth in a car or worldwide thru an intermediate server connecting all devices via cellular, 10 high-school students could all launch the app and act as both stage and player each user both broadcasting its own camera view or playing its music library and receiving low or medium resolution proxies from all other 9 devices. Having their headphones plugged in, they could then live switch between all of the players creating their own live composition for their listening pleasure and when season is done they could request the full high-res file to replace the low res in the final mix tape. In some situations, it may also be advantageous to include images or video or text from each player device to make a music video mix tape that incorporates both audio and visual imagery.

### 24. Use Case

### Multi-Camera Live Switching where Players Consist of Non-Connected Analog or Digital Recording Devices

Sometimes it is desirable to create a multi-camera movie or to make live-switching edit decisions while recording from cameras, microphones or other media capture devices that cannot possibly be connected to the stage in by any electronic means in both or either a send or receive configuration.

In these cases, the stage can manually define a type of PROXY player that shows on the stage-switching preview as a colored solid thumbnail with a user defined name or number. When the stage starts recording, a signal could be sent to the capture device either digitally or thru analog means (such as stage plays a beep tone or clap sound) or stage user could manually or by instruction to another person verbally or with hand signals or etc., trigger recording on this non-connected device (maybe stage can send infrared signal to trigger recording but device has no means of sending anything back to stage) and also a clapboard could be shown in front of camera or to give sound cue on audio microphone recording because the device may or may not have time code.

Once the stage stops recording, another command is executed to stop recording on device. Then, the film could be developed and scanned to a digital file or the tape could be ingested and transcoded or the disk file could be manually transferred to stage for replacement of the proxy clip. Audio waveforms or cues, clapboard images, time code or other means could be automatically precisely position and sync that media source in the multi-clip timeline relative to the other recordings. No editing would be required. For example, a movie producer to quickly live switch between three Panavision 35 mm film cameras could use this method. The stage would have a red, green and blue proxy thumbnail and stage would say “record now” and all three cameras would start recording and the stage could play a beep sound or flash a torch light in view of all three film cameras or a clapboard could be used. Over the course of 30 minutes, by looking at what each film camera is capturing instead of by looking at stage preview thumbnails, stage user could tap the desired proxy thumbnail during shooting to switch to that camera at that moment and so on. They might switch back and forth between the proxies 100 times. Then when the Panavision 35 mm film is developed and digitally scanned, the files would be imported by the stage and automatically or manually synced by timecode, beep tone, clapboard object motion detection or flash frame relative to the other files and relative to the live switching decision list. No editing or post would be required, the stage would automatically generate the final multi-camera movie and save it as a flattened movie file to disk. It is also possible in this use case to use a connected camera player device attached to the top of the lens of the film camera to provide better visual feedback on the stage of that camera's point of view instead of a solid color labeled proxy, stage would see this preview proxy and that would be replaced with the full res from film camera later.

### 25. Use-Case

### Multi-Camera Live Switching where Non-Smart-Device Digital Cameras (Third Devices) are Connected to the Stage Thru an Intermediate Proxy Player that Receives the Camera or Mic Signal Either Directly Via HDMI, VGA, Wi-Fi, Etc or Thru an Encoding or Streaming Server Device Connected to Both the Camera and the Player

In this case, imagine a RED ONE digital cinema camera that has no way of directly connecting to a player or stage device and is not a smart device in and of itself or doesn't have Wi-Fi. An intermediate device like a Teradek Cube could be connected to the RED ONE via its HD-SDI or HDMI1 out HD preview port. The Teradek cube would encode and compress that digital preview into thumbnails or low res stream that would be sent to the proxy player. This player, instead of (or in addition to) sending its own low-res camera feed to the stage, would instead or also forward the preview of the RED ONE being sent to it by the Terakdek Cube to the stage. When stage starts recording, a command would be sent to the proxy player which would in turn send a command either directly to the RED ONE or via the Teradek Cube connected to the RED ONE or another sync method would be used like beep tone or clapboard. When the recording is stopped, the Player would send the medium resolution to the stage or would request the high resolution from the Teradek Cube and after receipt transfer that to the stage to replace the low res thumbnails or proxy. In addition, the original hard disk file from the RED ONE containing the 4K or UltraHD (4 times HD) could be later imported to the stage and replace the proxy or high-res for super high res 4K final output. In some cases with some cameras or devices, the intermediate device could be eliminated and in others both the proxy player and intermediate device could be eliminated if the RED camera offers necessary smart connectivity and if network and processing bandwidth is not a constraint.

### 26. Computer Generated Emulated Live Player

In some cases, it may desirable to include in a composition a computer generated 3D rendering of the environment surround the stage or of some other environment relevant to the composition. For example, a user could be standing near the Eiffel tower on a cold morning and wanting to create a multi-camera composition but no players are available and no pre-recorded emulated player files on server match the current environment closely enough to provide an undetectable match with the stage users video. The server could have on it a 3D model of Paris with models of all buildings and the Eiffel Tower, when stage user sends out a request for players, the server could present a live video of the exact environment being created in real-time in the same way a 3D Video Game would render a live environment view for the player of the game. Environmental cues like weather, time of day, position and cycle of the moon and stars, cloud coverage and wind speed, detected audio or colors in stages video could be used to make the 3D rendering of Paris extremely realistic. Then the stage could select this emulated computer generated live player and start recording, switching back and forth between the two camera views to create a single composition.

### 27. Color Correction, Lens Correction or Audio Correction to Match Media Sources

Because each camera device or microphone may perceive visual images or sound differently, it may be necessary for the player, the stage or an interim server to make adjustments to both the low-res thumbnails or stream and the final high-res files transferred from each device so that they match each other in color, brightness, contrast, white balance (in the case of visuals) and match each other in tone, volume level and etc. (in the case of audio). This would happen automatically or manually by user input during recording to eliminate the need for post editing or correction. This happens when stage first selects players, the stage could send out a stream of itself for players to match or the stage could analyze incoming player streams and send commands to players to color correct or audio correct in real-time. It may also be necessary to apply lens correction, frame rate correction, scale adjustment or motion stabilization to match all footage. This would insure that live players or emulated live players match the stage and other players media as closely as possible so that when the event is over, the composition is truly complete and will not require editing or post-correction.

### 28. Live or Archived Photos or Fixed Video Used as Emulated Player Video Sources

In some cases, a player device may only be able to capture a still photo every few seconds or may have a boring locked-down camera view which makes it seem like a still photo. This could either be mixed into the composition as a frozen image or the image could be scaled or panned to create the appearance of live video. Filters could also be applied and layering effects could be overlaid such as snow falling or butterflies or clouds moving to make the still photo or fixed position video seem more lifelike and realistic and entertaining.

### 29. Green Screen or Vector Background Replacement and Multi-Camera Recording

One of the current limitations with current green screen recording technology and vector background replacement technology is that stock video backgrounds often do not match the studio lighting or lighting of the foreground clip. Because live and emulated live players transmit extended meta data about the sun position, temperature, weather and etc. it is possible to instruct the stage or another player recording the foreground subject to reposition the camera pointing in a different direction or to delay shooting until a different time of day for example to match other footage. For example, if a stage user is standing outside on a sunny day in Alaska in front of a green screen and wants to make a movie of an actor standing on a beach in Hawaii, the system could instruct the stage to point the camera west and wait 15 minutes for the sun angle in the archived emulated live player shot of a beach in Hawaii so that both shots would match perfectly and create a beautiful composition. Also, when the original player was recording the shot of the beach in Hawaii, the system could have asked that user to record another shot facing in the opposite direction so that the two clips could be later used as backgrounds for a two-person facing dialogue scene where it is necessary to have a shot facing west and a shot facing east. This is almost never possible with traditional stock footage. If the player is actually live in Hawaii at the same time the stage is live in Alaska, the system could provide instructions to both stage and player to make adjustments to their shooting angles so that combing the foreground and background would create an imperceptible match.

While the foregoing description and drawings represent the exemplary embodiments of the present invention, it will be understood that various additions, modifications and substitutions may be made therein without departing from the spirit and scope of the present invention as defined in the accompanying claims. In particular, it will be clear to those skilled in the art that the present invention may be embodied in other specific forms, structures, arrangements, proportions, sizes, and with other elements, materials, and components, without departing from the spirit or essential characteristics thereof. One skilled in the art will appreciate that the invention may be used with many modifications of structure, arrangement, proportions, sizes, materials, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1-48. (canceled)

49. A method of creating a final media composition using a media composition program residing on a first electronic device comprising a first display device, a first memory device, and first user input means, the method comprising:
a) receiving, on the first electronic device, a plurality of low resolution media streams of high resolution media clips from a plurality of remote electronic devices;
b) displaying, in the first display device, visual indicia of each of the low resolution media streams being received by the first electronic device;
c) activating one or more of the low resolution media streams being received by the first electronic device in response to user input via the first user input means;
d) for each low resolution media stream that is activated in step c), recording a low resolution media clip segment of that low resolution media stream in an interim media composition that resides on the first memory device;
e) for each low resolution media clip segment recorded in the interim media composition, receiving on the first electronic device a high resolution media clip segment from the remote electronic device that corresponds to that low resolution media clip segment; and
f) automatically replacing the low resolution media clip segments in the interim media composition with the high resolution media clip segments to create the final media composition comprising the high resolution media clip segments.

50. The method according to claim 49 wherein the interim media composition and the final media composition are the same singular file.

51. The method according to claim 49 further comprising:
wherein step d) further comprises:
d-1) for each low resolution media stream that is activated in step c), recording an extended low resolution media clip that comprises the low resolution media clip segment of that low resolution media stream on the first memory device separate from the interim media composition;
wherein step e) further comprises:
e-1) for each extended low resolution media clip recorded on the first memory device, the first electronic device receiving an extended high resolution media clip that corresponds to that extended low resolution media clip; and
wherein step f) further comprises:
f-1) recording the extended high resolution media clips on the first memory device;
f-2) extracting the high resolution media clip segments that correspond to the low resolution media clip segments of the interim media composition from the extended high resolution media clips recorded on the first memory device; and
f-3) replacing the low resolution media clip segments of the interim media composition with the extracted high resolution media clip segments.

52. The method according to claim 49 wherein step c) further comprises:
c-1) selecting one or more of the low resolution media streams being received by the first electronic device for recording in response to user input via the first user input means;
c-2) for each of the low resolution media streams selected in step c-1), recording an extended low resolution media clip of that low resolution media stream on the first memory device as a separate file;
c-3) activating one or more of the low resolution media streams selected in step c-1).

53. The method according to claim 49 further comprising:
wherein step c) further comprises: activating a first of the plurality of the low resolution media streams and a second of the plurality of the low resolution media streams; and
wherein step d) further comprises:
d-1) recording the low resolution media clip segment of the first low resolution media stream in the interim media composition; and
d-2) recording the low resolution media clip segment of the second low resolution media stream in the interim media composition.

54. The method according to claim 53 wherein the first and second low resolution media streams are activated sequentially, and wherein the low resolution media clip segment of the first low resolution media stream and the low resolution media clip segment of the second low resolution media stream are positioned sequentially in the interim media composition.

55. The method according to claim 53 wherein the first and second low resolution media streams are activated concurrently, and wherein the low resolution media clip segment of the first low resolution media stream and the low resolution media clip segment of the second low resolution media stream are positioned concurrently in the interim media composition.

56. The method according to claim 49 wherein step e) is automatically initiated upon an end record signal being generated by the first electronic device and being received by the remote electronic device.

57. The method according to claim 49 wherein step e) is automatically initiated upon determining that the high resolution media clip segments will be transmitted at a data rate that exceeds a predetermined threshold.

58. The method according to claim 49 wherein step e) is automatically initiated upon a window of the media composition program being opened or closed.

59. The method according to claim 49 wherein step e) comprises:
e-1) wirelessly uploading the high resolution media clip segments from the remote electronics device to a server; and
e-2) wirelessly downloading the high resolution media clip segments from the server to the first portable electronic device.

60. The method according to claim 59 wherein step e-1) is automatically initiated upon determining that the high resolution media clip segments will be wirelessly uploaded from the remote electronic devices to the server at a data rate that exceeds a predetermined threshold; and wherein step e-2) is automatically initiated upon determining that the high resolution media clip segments will be wirelessly downloaded from the server to the first electronic device at a data rate that exceeds a predetermined threshold.

61. The method according to claim 49 wherein step a) further comprises:
a-1) displaying a list of remote electronic devices that are available for remote connection;
a-2) selecting at least one of the remote electronic devices from the list; and
a-3) for each remote electronic device selected from the list, receiving the low resolution media stream of a high resolution media clip from that remote electronic device.

62. The method according to claim 61 wherein the remote electronic devices on the list are selected based on one or more qualification criteria defined by the user of the first electronic device via the first user input means.

63. The method according to claim 62 wherein the one or more qualification criteria are selected from a group consisting of local area network connectivity, GPS radius from the first electronic device, location of the remote electronic device and pre-defined group status.

64. A method of creating a video composition comprising:
a) displaying, in a first display device of a first portable electronic device, a first camera view perceived by a first camera lens of the first portable electronic device;
b) transmitting, to the first portable electronic device, a plurality of low resolution video streams of high resolution video clips previously stored in one or more databases;
c) displaying, in the first display device of the first electronic device, the low resolution video streams, wherein the first camera view and the low resolution video streams are simultaneously displayed in the first display device;
d) recording, on the first memory device of the first portable electronic device, a low resolution video clip for each of the low resolution video streams activated by a user as part of a video composition;
e) for each low resolution video clip recorded on the first memory device of the first portable electronic device, transmitting corresponding ones of the high resolution clips from the one or more databases to the first portable electronic device; and
f) automatically replacing the low resolution video clips in the video composition recorded on the first memory device of the first portable electronic device with the high resolution video clips.

65. The method according to claim 64 wherein step a) further comprises:
a-1) displaying, in the first display device, a list of high resolution video clips previously stored in the library database that satisfy qualification criteria;
a-2) selecting a plurality of high resolution video clips from the list via user input means of the first electronic device; and
a-3) transmitting, to the first portable electronic device, a plurality of low resolution video streams of the high resolution video clips selected in step a-2).

66. The method according to claim 65 wherein the qualification criteria comprises user-specified criteria and auto-extracted criteria.

67. The method according to claim 66 wherein the user-specified criteria comprises local area network connectivity, GPS radius from the first electronic device and location; and wherein the auto-extracted criteria comprises current weather conditions at a GPS location of the first portable electronic device, current time of day and current day and month.

68. A method of creating a final media composition using a media composition program residing on a first electronic device comprising a first display device, a first memory device, and first user input means, the method comprising:
a) displaying, in the first display device, a visual indicia for each of a plurality of electronic media recording devices;
b) recording, on each of the electronic media recording devices, a perceived event as a media clip that contains an electronic media recording device identifier;
c) selectively activating each of the visual indicia of the plurality of electronic media recording devices during step b) to generate and record a proxy clip segment in an interim video composition on the first memory device, wherein each proxy clip segment is associated with the electronic media recording device whose visual indicia was activated to generate that proxy clip segment and a temporal period;
d) for each proxy clip segment recorded in the interim media composition, receiving on the first electronic device the media clip recorded in step b); and
e) for each media clip received in step d), matching the media clip with the corresponding proxy clip segment based on the electronic media recording device identifier and automatically extracting a segment of the media clip that corresponds to the temporal period of that proxy clip segment; and
f) for each media clip segment extracted in step e), automatically replacing the proxy clip segment to which that media clip segment is matched with that media clip segment to create the final media composition comprising the media clip segments.
